(19) United States
(12) Patent Application Publication
(10) Pub. No.: US 2011/0211332 A1
(43) Pub. Date: Sep. 1, 2011

(54) REFLECTOR ELEMENT FOR AN ELECTRIC LAMP AND LAMP WITH SUCH A REFLECTOR ELEMENT

(75) Inventors: Achim Hilscher, Friedberg (DE); Andreas Hollstein, Karlskron (DE); Armin Konrad, Grossaitingen (DE); Thomas Noll, Kipfenberg (DE); Juergen Reichardt, Schwabmuenchen (DE); Ulrich Roll, Kissing (DE); Josef Schlecht, Poettmes (DE)

(73) Assignee: OSRAM GESELLSCHAFT MIT BESCHRAENKTER HAFTUNG, Muenchen (DE)

(21) Appl. No.: 13/034,740

(22) Filed: Feb. 25, 2011

(30) Foreign Application Priority Data
Feb. 26, 2010 (DE) 10 2010 002 379.5

(51) Int. Cl. F21V 7/22; F21V 9/16

(52) U.S. Cl. 362/84; 362/341; 362/296.02; 362/297

(57) ABSTRACT

A reflector element for an electric lamp is provided, wherein the reflector element is constructed in such a way that it is designed for photocatalysis and/or for color conversion of the light.

### CROSS-REFERENCE TO RELATED APPLICATION

This application claims priority to German Patent Application Serial No. 10 2010 002 379.5, which was filed Feb. 26, 2010, and is incorporated herein by reference in its entirety.

### TECHNICAL FIELD

The invention relates to a reflector element for an electric lamp and to an electric lamp with such a reflector element.

### BACKGROUND

In the case of flat lamps known from the prior art, a base, GX53, which has been developed specifically for these applications is used. Furthermore, lamps with light-emitting diodes as light sources in which a light-emitting diode (LED) module is formed as part of the luminaire have become established on the market. Said light-emitting diode module is connected to the electronic driver of the light-emitting diodes without the use of a base/fitting system and is connected in thermally conductive fashion to the luminaire body, which then acts as heat sink, for the purpose of dissipating the heat generated in the light-emitting diode chip.

Furthermore, in the case of lamps with a base/fitting system, a lampholder is required and different codings for the base/fitting system are required in order to be able to prevent unsuitable lamps from being inserted into the fitting. Furthermore, in this respect the lamps are designed to be bigger and complex installation in view of the lines, the wiring thereof and the fastening of the lamp as well as the luminaire to the fitting are required. Furthermore, symmetrical configurations of a luminaire cannot be realized, not least because increased material consumption is required and only a restricted luminous efficacy is ensured.

The term flat lamp is understood to mean a lamp which is formed with a two-dimensional geometry. In particular, the flat lamp should be understood to the extent that the physical height of the light source is smaller, in particular substantially smaller than the width and the depth of the light source. The term flat lamp should therefore be understood to mean lamps in which one or more light sources are arranged in a plane, but also lamps in which a discharge lamp is used as the basis and the discharge vessel extends in one plane or, for example, is also slightly conical. Even in the case of a conical form, however, the dimensions should be such that the height of the cone is smaller, in particular much smaller, than the radial dimensions. In particular, flat lamps can be substantially disk-shaped.

Owing to their design and construction, conventional flat lamps are problematic to the extent that the electronic operating device and other components can heat up and can thus fail, and therefore the service life of these lamps is kept within limits. Furthermore, owing to this design, the luminous efficacy is limited. In addition, a symmetrical design of the lamp and the luminaire is more often not possible. This results again in losses in the light emission and the luminous efficacy. Owing to reflector losses, the possibility of rotatability of a luminaire with such a lamp is also not provided.

### SUMMARY

Various embodiments provide a reflector element and an electric lamp and e.g. a flat lamp with such a reflector element, with which the illumination can be improved.

A reflector element according to various embodiments for an electric lamp is constructed in such a way that it is designed at least for photocatalysis and/or for color conversion of incident light, e.g. light emitted by the electric lamp.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a schematic sectional illustration through various embodiments of a lamp according to various embodiments;

FIG. 2 shows a schematic sectional illustration through various embodiments of a lamp according to various embodiments;

FIG. 3 shows a schematic sectional illustration through various embodiments of a lamp according to various embodiments;

FIG. 4 shows a schematic sectional illustration through various embodiments of a lamp according to various embodiments;

FIG. 5 shows a schematic sectional illustration through various embodiments of a lamp according to various embodiments;

FIG. 6 shows a sectional illustration through an embodiment of a heat sink, as it is formed by way of example in the embodiment shown in FIG. 5;

FIG. 7 shows a schematic sectional illustration through a luminaire in accordance with various embodiments, in which a lamp is arranged;

FIG. 8 shows a schematic side view of the lamp of the luminaire shown in FIG. 7;

FIG. 9 shows a plan view of various embodiments of a lamp;

FIG. 10a shows a schematic sectional illustration of a detail of various embodiments of a luminaire with a lamp inserted;

FIG. 10b shows a further schematic sectional illustration of a detail of a luminaire with a lamp inserted as shown in FIG. 10a;

FIG. 11 shows a schematic plan view of various embodiments of a lamp;

FIG. 12 shows a schematic plan view of part of various embodiments of a luminaire;

FIG. 13 shows a plan view of various embodiments of a luminaire;

FIG. 14 shows a schematic plan view of various embodiments of a lamp;

FIG. 15 shows a schematic sectional illustration of various embodiments of a lamp according to various embodiments;

FIG. 16 shows a plan view of a lamp carrier of a luminaire in a first manufacturing state;

FIG. 17 shows a side view of the lamp carrier in accordance with the first manufacturing state;

FIG. 18 shows a plan view of the lamp carrier in accordance with a second manufacturing state;

FIG. 19 shows a side view of the lamp carrier in the corresponding manufacturing state shown in FIG. 18;

FIG. 20 shows a further side view of the lamp carrier with additional elements;

FIG. 21 shows a schematic plan view of the luminaire in various embodiments;

FIG. 22 shows an illustration from the side of the luminaire shown in FIG. 21;

FIG. 23 shows various embodiments of a plan view of a lamp carrier of a luminaire in a specific manufacturing state;

FIG. 24 shows a further plan view of the lamp carrier shown in FIG. 23 in a subsequent manufacturing state;

FIG. 25 shows a further plan view of the luminaire shown in FIG. 23 and FIG. 24 in a further, subsequent manufacturing state;

FIG. 26 shows a side view of the luminaire shown in FIG. 25;

FIG. 27 shows a plan view of a detail of a luminaire;

FIG. 28 shows a plan view of a detail of the luminaire with the lamp introduced;

FIG. 29 shows a plan view of a detail of the luminaire with the lamp in the fitted final installed position;

FIG. 30 shows a plan view of various embodiments of the luminaire;

FIG. 31 shows a plan view of a luminaire system with two separate luminaires;

FIG. 32 shows a schematic plan view of various embodiments of the luminaire system shown in FIG. 31 with the luminaires assembled;

FIG. 33a shows a sectional illustration through various embodiments of a lamp according to various embodiments with a reflector element;

FIG. 33b shows a sectional illustration through various embodiments of a lamp according to various embodiments with specific reflector elements;

FIG. 33c shows a sectional illustration through various embodiments of a lamp according to various embodiments with specific reflector elements;

FIG. 34a shows an enlarged illustration of a detail of a reflector of the lamp in FIG. 33a;

FIG. 34b shows an enlarged illustration of a detail of a reflector of the lamp in FIG. 33b;

FIG. 34c shows a simplified illustration of the reflection response of the first reflector element in FIG. 33c;

FIG. 34d shows a simplified illustration of the reflection response of the second reflector element in FIG. 33c;

FIG. 35 shows a schematic plan view of a luminaire with a lamp installed;

FIG. 36 shows various embodiments of a lamp according to various embodiments in a schematic sectional illustration;

FIG. 37 shows a schematic sectional illustration through various embodiments of a lamp according to various embodiments;

FIG. 38 shows a schematic sectional illustration through a detail of various embodiments of a lamp according to various embodiments;

FIG. 39 shows a schematic sectional illustration through a detail of various embodiments of a lamp according to various embodiments;

FIG. 40 shows a schematic sectional illustration of a detail of various embodiments of a lamp according to various embodiments;

FIG. 41 shows a diagrammatically perspective illustration of various embodiments of a luminaire with a plurality of lamps of different lamp types; and

FIG. 42 shows a plan view of various embodiments of a lamp.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

First, a few lamp configurations will be explained, said lamp configurations being formed with at least one reflector according to the invention or an advantageous embodiment thereof, but the reflector initially not being illustrated for reasons of clarity but then being explained additionally below.

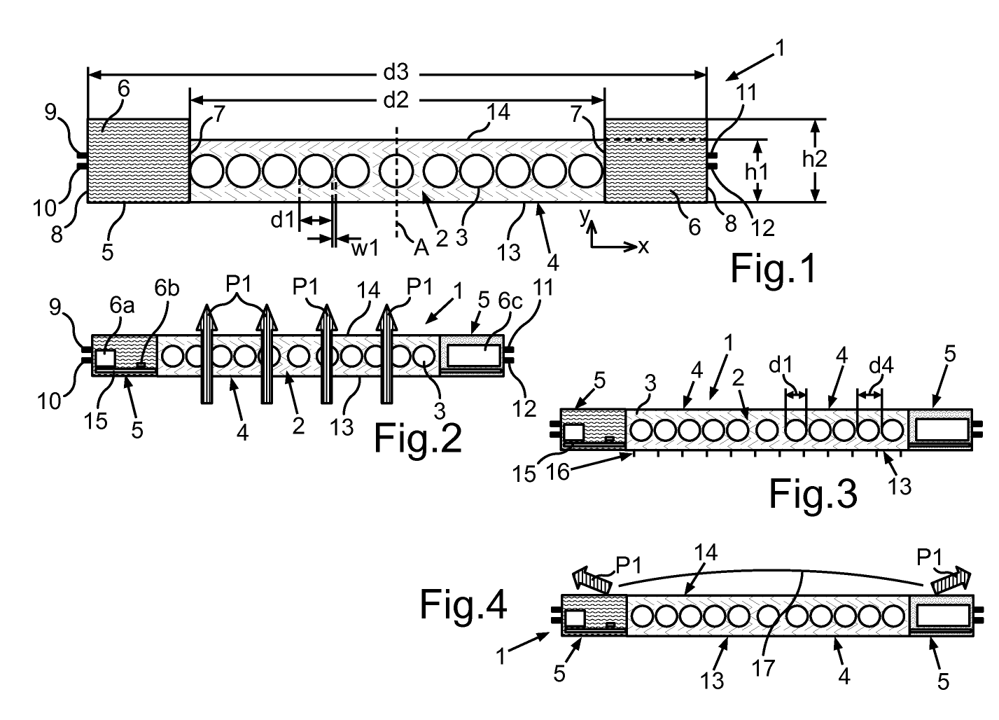

FIG. 1 shows a schematic sectional illustration of a varios embodiments of a lamp 1 according to varios embodiments. In this configuration, the lamp 1 is in the form of a discharge lamp. The lamp 1 may include at least one light source 2, which may include a discharge vessel 3, which is a multiply wound tube. In varios embodiments, the discharge vessel 3 may be wound in helical fashion in one plane or can be wound in helical fashion and can have a conical shape, in which case the height of the cone is substantially smaller than the width and the depth and therefore the radial dimension. The lamp 1 is a flat lamp and in this regard is defined correspondingly in particular on the basis of the configuration of the discharge vessel 3. In varios embodiments, the discharge vessel 3 is arranged in a plane which extends perpendicular to the plane of the figure and has the x axis.

The light source 2 and therefore also the discharge vessel 3 are arranged in a second housing part 4, which is integrally connected to a first housing part 5. In this first housing part 5, an electronic operating device 6 for the lamp 1 is arranged, with the result that, in this regard, the electronic component parts of the operating device 6 are arranged in this first housing part 5. In various embodiments, the lamp 1 is in the form of a flat disk or cylinder and the first housing part 5 surrounds the second housing part 4 and therefore also the discharge vessel 3 circumferentially. In respect of the radial design, the second housing part 5 is therefore designed so as to extend circumferentially on the circumferential side of the first housing part 4 and the operating device 6 therefore surrounds the discharge vessel 3 circumferentially. When viewed in the radial direction, and therefore in the x direction, the operating device 6 is therefore arranged radially further outwards than the discharge vessel 3. The operating device 6 is therefore arranged circumferentially to the side of the discharge vessel 3 and on the outside with respect thereto.

In various embodiments, a distance w1 between two adjacent tube turns of the discharge vessel 3 is in the range from about 0.4 mm to about 3.5 mm, e.g. <1 mm. In various embodiments, a ratio between a distance w1 between two turns and an outer diameter d1 of the tube of the discharge vessel 3 may be in the range from about 0.03 to about 0.3, e.g in the range from about 0.02 to about 0.2. Provision may be made for this ratio to be >0.05 and <0.2.

As can be seen from the illustration in FIG. 1, the second housing part 4 has a height h1 (extent in the y direction), which is 12 mm. In the embodiments shown, provision is made for a height h2 of the second housing part 5 in which the operating device 6 is located to be greater than the height h1. In various embodiments, this height h2 is e.g. 18 mm.

Provision may also be made for the height h2 to be equal to the height h1 or even to be less than the height h1.

Furthermore, provision is made in various embodiments for a diameter d2 of the second housing part 4 to be 80 mm in various embodiments, whereas an outer diameter d3 of the second housing part 5 and therefore of the entire lamp housing is 120 mm in various embodiments. As has already been mentioned, the two housing parts 4 and 5 are in the form of an integral housing.

Provision may be made for a circumferential dividing wall 7 to be formed between the housing parts 4 and 5, with the result that the discharge vessel 3 is separated from the component parts of the operating device 6. Provision may also be made for this dividing wall 7 not to be provided.

By virtue of such a configuration of a lamp 1, said lamp can be configured so as to have a particularly flat design and, furthermore, light emission is possible on both sides in the y direction, with the result that upward and downward light emission is possible in the sectional illustration shown in FIG. 1. In various embodiments shown, in each case two electrical contacts 9, 10 and 11 and 12 are formed on a side wall 8, which at the same time also forms the circumferential lateral surface of the first housing part 5, on opposite sides. The lamp 1 therefore may include four electrical contacts, which can be e.g., in the form of contact pins, spring contacts or sliding contacts. In this context, two electrical contacts 9 to 12 are designed to make contact with the mains voltage lines, whereas a third electrical contact 9 to 12 is designed for making contact with ground potential and a fourth electrical contact 9 to 12 is designed for transmitting control signals for adjusting the brightness and/or the coloration of the light generated by the lamp 1.

The electrical contacts 9 to 12 are formed at mutually opposite points in such a way that they are positioned on a straight line through the center point of the circular lamp 1 in the event of projection on to the lamp plane.

In various embodiments shown in FIG. 1, the lamp 1 therefore may include a base, which is formed on the housing part 5 virtually in the region of the electrical contacts 9 to 12, with the result that the lamp 1 with this configuration of the base can be inserted into a corresponding fitting of a lamp carrier of a luminaire. In this regard, the embodiments of the lamp shown in FIG. 1 may be introduced into a luminaire with a fitting and, in this regard, a base/fitting system can be provided as electrical contact system.

In accordance with the illustration shown in FIG. 1, the lamp 1 is therefore formed with an integrated operating device 6, e.g. an integrated ballast.

Provision may also be made for the lamp 1 to have a cooling tube for decreasing the cold spot temperature in the center and therefore in the region of the longitudinal axis A of said lamp, which longitudinal axis also represents the axis of rotation.

Provision may be made for the electronic component parts of the operating device 6 to be arranged circumferentially in such a way as to be distributed substantially uniformly over the discharge vessel 3. Provision may also be made for the first housing part 5, which extends completely circumferentially and therefore in the form of a ring around the discharge vessel 3, to have electronic component parts of the operating device 6 only in specific segments of a circle.

In various embodiments, the dimensions of the diameters d2 and d3, which describe the diameters of the first and the second housing parts 5 and 4, respectively, can be constructed in such a way that a ratio between the outer diameter d3 and the outer diameter d2 is >1.2 and <2.0, in particular >1.4 and <1.7, and preferably 1.5.

Provision may be made for the lamp 1 furthermore to also have light-directing elements, such as one or more reflectors, one or more scattering disks or a grid or a diaphragm limiting convection, for example, wherein these elements are not illustrated in FIG. 1. These elements can preferably be located on a lower side or front side 13 or on an upper side or rear side 14 in such a way as to be spaced apart from or in direct contact with the second housing part 4 in the region of said second housing part. The light-directing element or the diaphragm is fastened e.g. on the upper or lower side of the first housing part in a position intended for this purpose. Since provision may be made for the elements to be replaceable as desired, e.g. provision may be made for this interface to be standardized.

Provision may also be made for a device for holding the lamp 1 to be provided on the first housing part 5 and/or the second housing part 4.

In various embodiments, provision is also made for a convection-driven, controlled air exchange to take place at least in a subregion between the upper side and the lower side of the lamp 1, said air exchange being formed by the use of convection-influencing elements, such as a diaphragm, a grid or a reflector, for example, in the case of low-pressure discharge lamps or a heat sink in the case of light-emitting diodes being used as light sources. The air exchange may be adjusted e.g. in such a way that optimum operating conditions can be set for the respectively used lamp 1. This may be seen in a low-pressure discharge lamp to the extent that a cold spot temperature is set within the range from about 40° to about 50° C. In the case of a lamp equipped with light-emitting diodes as light source, this controlled air exchange takes place in such a way that the junction temperature describing the luminous efficacy of the LED chip is as low as possible, e.g. <70° C. Given a further lamp type, in which the light source is a halogen light source, this is set in such a way that the pinch temperature which is relevant for the life of the lamp is as low as possible, in particular <350° C.

Furthermore, provision may also be made for the front side 13 and/or the rear side 14 to be formed so as to be at least partially open, with the result that the heat produced during operation can flow out of the second housing part 4 towards the outside. In various embodiments, provision may also be made for in addition also the first housing part 5 to be formed so as to be partially open at least at specific points, with the result that, in this case too, the heat can be transported away from the second housing part 5. If the dividing wall 7 is provided, provision may optionally also be made for this dividing wall 7 to have corresponding openings, with the first housing part 5 also having such openings e.g. in this case.

In respect of the generation of the throughflow, a blower (not illustrated) or a fan may optionally also be arranged, said blower or fan preferably being arranged in the region of the first housing part 5 or in the region of a heat sink.

FIG. 2 shows a further schematic sectional illustration of various embodiments of the lamp 1. Said lamp is again in the form of a discharge lamp, and it can be seen that, in contrast to the configuration shown in FIG. 1, the physical height of the first housing part 5 is equal to the physical height of the second housing part 4.

Furthermore, by way of example, electronic components parts 6a, 6b and 6c of the electronic operating device 6 are illustrated, said electronic component parts being arranged on a circuit carrier 15, which is in the form of a ring circuit board, for example.

The arrows P1 in this case symbolize, by way of example, the convection flow which flows through the front side 13 and rear side 14 which have been provided with openings.

FIG. 3 shows a further sectional illustration of various embodiments of the lamp shown in FIG. 2, in which case a grid 16 is formed in the region of the front side 13 of the second housing part 4. The grid may also be connected electrically to protective earth, which is provided by one of the contacts 9 to 12, which results in a reduction in electrosmog.

The grid shown in FIG. 3 can additionally also be in the form of an anti-glare element, with the result that glare is avoided.

FIG. 4 shows various embodiments of the lamp 1 in a sectional illustration, with the lamp 1 being formed so as to correspond to the illustration in FIG. 2 or 3 and having a light-directing element adjacent to the rear side 14, which light-directing element can be a reflector 17, for example. Said light-directing element can be at least partially reflective, in which case reflection is also understood to mean scattering, with the result that a scattering disk can also be formed here. The reflector 17 may also be arranged on the opposite side and therefore adjacent to the front side 13 of the second housing part 4.

Furthermore, the arrows P1 again indicate the convection through the openings in the rear side 14 and possibly also openings in the first housing part 5.

In the embodiments shown in FIG. 1 to FIG. 4, in which the lamp 1 is in the form of a discharge lamp, cooling of the cold spot to approximately 40° C. to 55° C. is achieved by the air exchange, depending on the tube diameter, with this regulation of the air exchange taking place via the area and the temperature gradient between the top and the bottom of the lamp, which is substantially dependent on the specific power per unit area and on the ambient temperature.

By virtue of the grid 16 and/or the reflector 17, in conjunction with the openings in the second housing part 4 and/or the first housing part 5, controlled and adjustable convection can be enabled.

In various embodiments, the reflector 17 and/or the second housing part 4 is coated with TiO₂. By virtue of such a configuration, efficient air purification can also be enabled by the adjustable convection, with the coating with the mentioned material preferably being formed on the housing outer side.

Provision may also be made for the grid 16 to be designed to be integral in the first housing part 5 and/or in the second housing part 4. However, it is likewise also possible for a detachable connection to be provided, with the result that this detachable connection can be removed and positioned again reversibly at any time without causing any destruction. As a result, the lamp can be reconfigured in a simple manner with quick manipulation to the extent that it can be designed either for bidirectional emission of light or for emission upwards or for emission downwards.

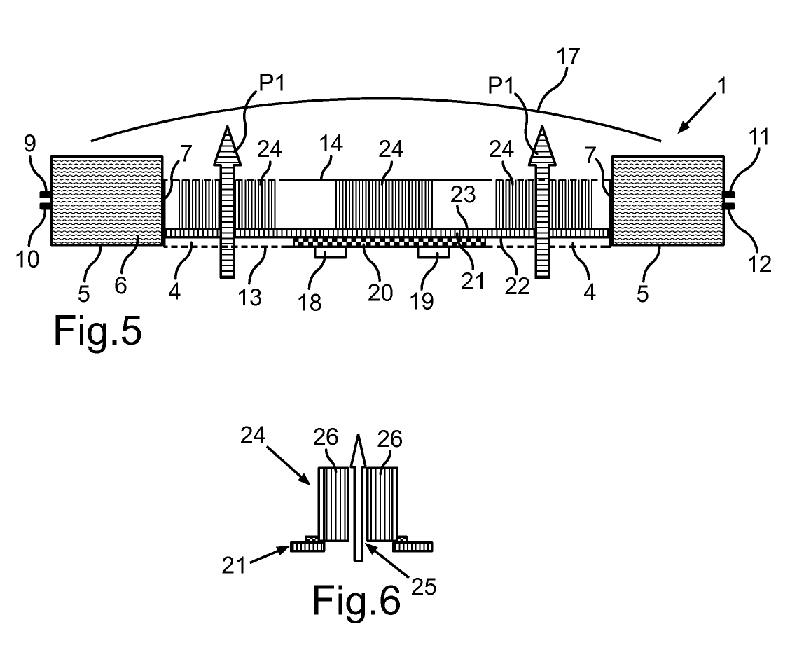

FIG. 5 shows a further simplified sectional illustration through various embodiments of a lamp 1. In contrast to the configuration of the lamp shown in FIGS. 1 to 4, in this case there is no discharge lamp, but the light sources of the lamp 1 in FIG. 5 are in the form of semiconductor components, e.g. in the form of light-emitting diodes 18 and 19. In this case, too, the figure shows an embodiment in which the first housing part 5 is higher than the second housing part 4.

The light-emitting diodes 18 and 19 shown merely by way of example in terms of number and position are arranged on a plate-like carrier 20. Said carrier is fixed on a cooling plate 21 on the lower side 22 thereof. In various embodiments, three heat sinks 24 are arranged on an upper side 23 of the cooling plate 21, said heat sinks 24 being located in the second housing part 4, in the same way as the cooling plate 21. In this case too, the second housing part 4 is formed on the front side 13 and the rear side 14 with openings, with the result that convection in accordance with the arrow illustration P1 takes place here too. The height of the heat sinks can also be greater than that shown in FIG. 5, e.g. when it is envisaged that the luminaire is attached so as to be spaced apart from the ceiling or wall.

Provision may also be made for the heat sink 24 to be part of the luminaire and, with respect to cooling power, is designed to be substantially more efficient than the heat sinks, which are part of the lamp and are therefore delimited at the top, as far as the areal extent is concerned, to a disk with a diameter d2.

In this case too, the dividing wall 7 can be provided between the first housing part 5 and the second housing part 4.

Furthermore, FIG. 5 shows embodiments in which an anti-contamination shield is positioned on the side facing the rear side 14. In the same way as the other light-directing elements, this shield is preferably fixed to the first housing part 5 and is used for trapping dirt particles which flow through the lamp via convection. In the same way as the reflectors or scattering disks, this element can also be removed for cleaning. In addition, the anti-contamination shield can also perform the function of convection limitation. In various embodiments, the carrier 20 is formed from aluminum.

In addition to or instead of the reflector 17, both in the embodiments of the lamp 1 shown in FIGS. 1 to 4 and in the embodiments of the lamp 1 shown in FIG. 5, the contamination prevention element or the anti-contamination shield can be provided, with the result that, in this respect, the regions located behind the lamp 1, such as the ceiling or wall, do not become contaminated with dust or similar impurities. This contamination prevention element can also be provided on its own, with the result that, in this respect, a lamp can also be formed which only has this element, but no reflector 17.

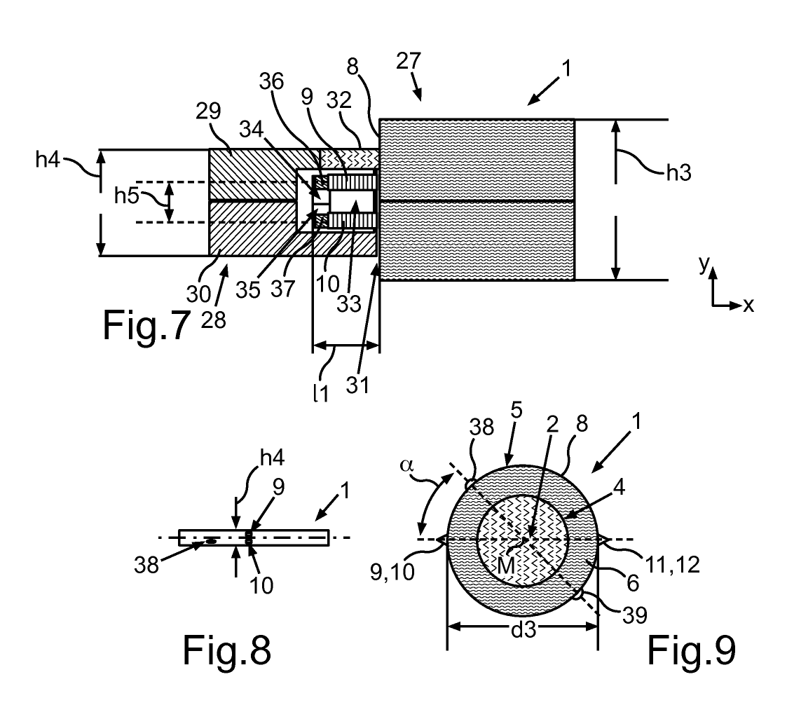

FIG. 6 shows a sectional illustration through various embodiments of a heat sink 24. This heat sink 24 is in the form of a cylinder and has a central opening. Furthermore, radially oriented cooling walls 26 are formed in the interior of the cylinder, the cylinder wall e.g. having a much greater material thickness than the radial cooling walls around which air flows. This can be seen in the plan view illustration shown in FIG. 7.

Provision may also be made for the carrier plate 20 to be in the form of a cooling plate and e.g. in the form of a continually-cast profile. In particular, no explicit heat sinks 24 are then provided.

In various embodiments, in the case of the lamp shown in FIG. 5 and also in the case of the lamp shown in FIG. 4 and generally in the case of lamps which are provided for convection-driven air exchange corresponding to the configurations in FIG. 1 to FIG. 5, a cover for trapping dirt particles which arise owing to this convection-driven air exchange and are guided upwards is formed primarily when the luminaire is fixed close to the ceiling.

If a reflector 17 is provided, in a discharge lamp in accordance with the illustration in FIG. 3 and FIG. 4 provision is made for a ratio between the outer diameter d1 of a tube of the discharge vessel 3 and a distance d4 determined on one side of two adjacent tube parts of the discharge vessel 3 to be between <1.5 and >3.

Precisely when a reflector 17 is provided, provision is preferably made for the discharge vessel 3 to have, on its inner side on the side facing the reflector 17, a thicker phosphor layer than on the side remote from the reflector 17. In various embodiments, the ratio of the layer thicknesses between the layer thickness on the side facing the reflector and the side remote from the reflector is <2 and >5. Precisely when such a reflector 17 is intended to be provided in a lamp 1, and said lamp is in the form of a discharge lamp, an additional reflector layer is applied to the inner side of the discharge vessel 3, said additional reflector layer e.g. reflecting light in the spectral range which is visible to humans towards the front and therefore in the direction of that side of the housing which is remote from the reflector 17.

FIG. 7 shows a schematic sectional illustration of a detail of a luminaire 27, which has a lamp 1 in the form of a flat lamp, it being possible, for example, for the lamp 1 to be designed in accordance with one of the embodiments shown in FIG. 1 to FIG. 5. Furthermore, it is also possible for the lamp 1 to have a different configuration than a flat lamp, wherein in this context reference is made to explanations below relating to other exemplary embodiments of lamps.

The luminaire 27 may include a plate-like lamp carrier 28, which, in various embodiments, has a cutout 29 into which the lamp 1 can be inserted. It can be seen that the lamp 1 is higher in respect of its physical height (extent in the y direction) than the lamp carrier 28. In this regard, the lamp 1 is formed with a height h3 of 12 mm, for example. In contrast, the height h4 of the lamp carrier 28 is 8 mm, in various embodiments. As will be mentioned again and explained further later in the text, the lamp carrier 28 can be a single plate or can comprise two separate plates. In various embodiments, the lamp carrier 28 is formed from two separate plates 29 and 30, which are assembled. The two plates 29 and 30 can be connected to one another, for example, via the construction of the luminaire suspension system.

By way of example, the figure shows the electrical contacts 9 and 10, which are arranged directly one above the other in the y direction and are in the form of contact springs. The upper plate 29 has a recess 32, into which the contact pins 9 and 10 and a locking element (not shown), which is likewise formed on the outer side 8 of the lamp 1, can be inserted. The cutout 31 in the lamp carrier 28 is designed for completely accommodating the lamp 1 and is a through-hole in the exemplary embodiment shown.

The extent of the elements for making the electrical contact in the base/fitting system, including the contacts 9 and 10 and the luminaire-side contact element 35, have a length l1 which is 6 mm, for example, in various embodiments. Furthermore, a respectively opposite recess is produced in the two plates 29 and 30, with the result that, in this regard, an undercut zone 33 is also formed, into which the contact pins 9 and 10 can be introduced and can be rotated with a view to reaching and setting the final installed position with the lamp 1 and the axis A thereof. The geometry of the undercut zone can be considered to be a circular ring around the lamp axis A, which is adjoined on the lamp side by the cutout 31. In this sense, the rotatability can be considered as being via a longitudinal axis which extends in the y direction.

To this end, said recesses 34 and 35 in the form of grooves are formed in the region of the undercut zone 33, and then the electrical contacts 9 and 10 extend into said recesses. In the embodiments shown, the two electrical lines 36 and 37 are arranged in integrated fashion in these grooves 34 and 35 and, in the embodiments shown, have an angular cross section.

In the embodiments shown, the two electrical contacts 9 and 10 have a vertical distance h5, which is 3 mm in the various embodiments.

In respect of the dimensions, an insertion slot 32 can be formed with the following dimensions: a length of 4.5 mm, a width of 1.5 mm and a depth of 3 mm. The undercut zone 33 may be realized with the following dimensions: 4 mm in the y direction and 4.75 mm for the circumferential extent (x direction). The electrical contacts 9 and 10 may have extents such that they are formed with or without a spring excursion, wherein a length of 5 mm up to a length of between 1 mm and 6 mm is advantageous without a spring excursion. Without a spring excursion, a length of 3.8 mm may be advantageous. The width may be 1.2 mm and the depth may be 1.5 mm. In respect of their cross-sectional dimension and therefore their polygonal shape, the two lines 36 and 37 may have a square configuration with a side length of 1 mm.

The grooves 34 and 35 may be formed with a length of 1.25 mm and a width of 1.6 mm. In respect of the length, this relates to the extent in the x direction, the width relates to the extent in the y direction and the depth to the extent in the direction of the z axis, which extends perpendicular to the plane in the figure, i.e. in the case of a linear luminaire in the direction of the axis of the luminaire.

FIG. 8 shows a schematic side view of a lamp 1.

The figure shows the arrangement of the contacts 9 and 10 one above the other, when viewed in the vertical direction. Furthermore, the figure shows a locking element 38, which is formed on the side wall 8 of the lamp in such a way as to be circumferentially spaced apart from the electrical contacts 9 and 10 and engages in a corresponding cutout in the lamp carrier 28 for fixing the position of the lamp in the lamp carrier 28.

FIG. 9 shows a schematic plan view of various embodiments of a lamp 1, which has a disk-shaped configuration. The figure also shows that the electronic operating device 6 is arranged in a first housing part 5 which runs annularly around the light source 2 and the second housing part 4. The electrical contacts 9 and 10 on one side and the electrical contacts 11 and 12 on the other side are formed on the lateral surface or side wall 8 of the first housing part 5 on opposite sides. The projection of the contacts into the plane of the lamp is therefore arranged on a straight line through the center point M of the lamp 1, with the electrical contacts 9 and 10 being positioned vertically one above the other, and this applying correspondingly to the electrical contacts 11 and 12. In this regard, reference is made to the exemplary illustration in FIG. 7.

Furthermore, the first locking element 38 and a second locking element 39 are formed on this side wall 8. The projection of said locking elements into the plane of the lamp is arranged on a straight line through the center point M. Furthermore, in various embodiments, they are arranged so as to be spaced apart from the respective electrical contacts 9 and 10 or 11 and 12 at an angle α of α 45°. In accordance with the embodiments shown, the locking elements 38 and 39 are in the form of hemispheres and e.g. have a height of between 1 mm and 5 mm, e.g. 3 mm.

The lamp 1 can be designed in accordance with the embodiments in FIG. 1 to FIG. 5 and, in this regard, the lamp type may be a discharge lamp or an LED lamp. Furthermore, however, it can also be a halogen lamp, for example, wherein in this context the light source of the lamp 1 is a halogen light source.

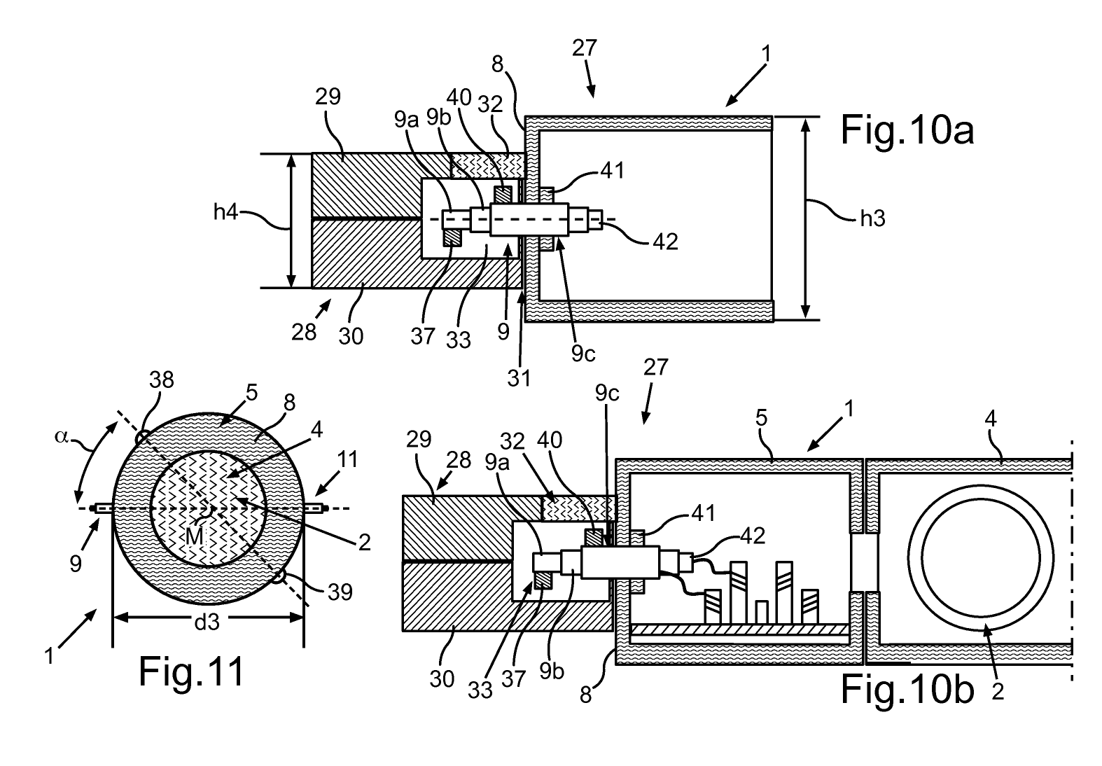

FIG. 10a shows a further exemplary embodiment of a luminaire 27, with only a detail of the entire luminaire 27 being illustrated in this case too. In this case too, a flat lamp which, in terms of its height h3, is greater than the height h4 of the lamp carrier, is introduced in an analogous configuration with respect to the illustration in FIG. 8. The lamp carrier 28 is in turn constructed from two separate plates 29 and 30. In this case, a base/fitting system is formed which is formed by the configuration of the lamp carrier 28 and the electrical contacts.

In contrast to the configuration shown in FIG. 7, in this case the electrical lines 36 and 37 are arranged in the lamp carrier 28 in a manner which is not directly one above the other in the vertical direction, but are arranged furthermore so as to be offset with respect to one another in the x direction, although they are positioned one above the other vertically.

In the embodiments shown, this is necessary because the lamp 1 on this side does not have two separate contacts 9 and 10 which are arranged so as to be spaced apart from one another, but merely has a single contact 9 in the form of a contact pin, said contact 9 being in the form of a twin contact. This means that said contact has a first contact region 9a, which is in the form of an inner pin and protrudes forwards and makes contact with the lower line 37. This first contact part 9a is surrounded circumferentially by electrical insulation 9b. This electrical insulation 9b is then in turn surrounded by a second contact part 9c, which in the various embodiments are in electrical contact with a control line 40. Signals for adjusting the brightness and/or the coloration of the light emitted by the lamp 1 are transmitted via this control line 40. For reasons of protection against electric shock, the mains lines are in this case further arranged spaced apart from the lamp axis A, and those which do not conduct a high voltage, such as signal lines and protective earth, for example, are e.g. arranged closer to the cutout.

Electrical contact is thus produced between the contact 9 in the form of a twin contact and the one mains line 37, on one side, and the control line 40, on the other side, wherein this takes place via the two contact parts 9a, 9c, which are separate but are combined in a contact pin and which are formed coaxially. On the operating device side, a control line 9c is provided which is housed via a polymer part 41, via which the signals of the luminaire-side signal or control line 40 are passed on, as well as a lamp-side mains line 42, via which the mains signals of the line 37 are passed on.

In one example, the mains lines are connected to the first double pin, and protective earth and the signal line are connected to the second double pin. In the case of the realization of the SELV principle, i.e. when a DC voltage of <60V is supplied to the lamp-side operating device via a second operating device in a third housing part, the first double pin should preferably conduct the DC voltage and the second double pin should be reserved for two signal lines for “receiving” and “transmitting” signals.

FIG. 10b shows a further example of a lamp 1, wherein, by way of supplementing the illustration in FIG. 10a, in addition the second housing part 4 is also partially illustrated and the leadthrough between the first and the second housing part 5 and 4, respectively, for lines is shown.

FIG. 11 shows a plan view of a lamp 1, as can be used in FIGS. 10a and 10b in the luminaire 27 shown therein or the lamp carrier 28. On opposite sides of the side wall 8, one twin contact in the form of the electrical contact 9 which then also comprises the contact 10 (not described in any more detail) and a second twin contact in the form of the electrical contact 11 which is likewise in the form of a contact pin and surrounds the contact 12 (not described in any more detail) are shown. In respect of the configuration of the lamp carrier 28 in the region of the electrical contact 11, there is an analogy with respect to the illustration in FIG. 11. The electrical contact 11 in the form of a twin contact is furthermore analogous with respect to the illustration in FIG. 11 in relation to the electrical contact 9, wherein, in this regard, the inner contact part is electrically connected to the further mains line 36.

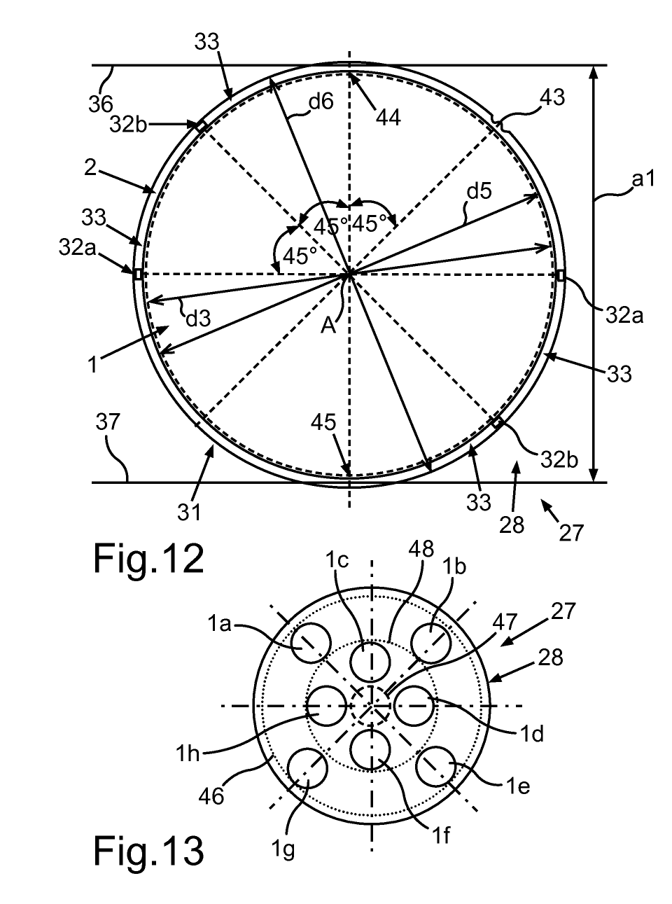

In respect of the mains lines 36 and 37, said lines are arranged virtually at the bottom in the configuration shown in FIG. 12 of the lamp 1, as a result of which protection against electric shock is also formed in this regard. In respect of the control line 40 and the connection to protective earth formed on the opposite side, with the electrical contact 11 being connected to protective earth, no such protection against electric shock is required.

With a view to inserting the lamp 1 into a cutout 31 in the lamp carrier 28, the disk-shaped lamp 1 is first inserted in the direction of its longitudinal axis A, which extends in the y direction, and the electrical contacts 9 to 12 and the locking elements 38 and 39 are introduced via correspondingly shaped insertion slots 32, and so to speak through the upper plate 29. After this insertion, the lamp 1 preferably rests against the locking elements 38 and 39 on the lower side of the undercut zone 33, as a result of which mechanical loads on the electrical contacts 9 to 12 are avoided. The electrical contacts 9 to 12 and the locking elements 38 and 39 are freely rotatable about the longitudinal axis A of the lamp 1 in the undercut zone 33 as far as the region of the zone where an inwardly directed shaped portion is provided for each locking element 38 and 39, wherein the locking elements 38 and 39 latch into said shaped portion once a certain force expenditure has been exceeded.

In respect of the configuration of the luminaire 27, a base/fitting system is therefore designed for connection to the lamp 21, wherein the fitting is part of the lamp carrier 28. All of the fitting elements are incorporated in said lamp carrier 28, wherein in this regard e.g. an insert is provided as an injection-molded part, said insert containing all of these mechanical fitting elements apart from the power supply lines. A particular property of this base/fitting system can be considered to be that the contacts which are normally present in a fitting are not physically present and that the function thereof is performed by the preferably square lines 36 and 37 which are laid in the luminaire and the lines therefor which run on the other side of the luminaire 27 and are not characterized in any more detail or illustrated in any more detail.

In various embodiments, the electrical contact is made between the electrical contacts 9 to 12 and the lines 36, 37, 40 and 41 purely via bending torques which result given a corresponding configuration of the dimensions relative to the contact pin diameter and the distance between the luminaire-side wires or lines and the materials. As a result, virtually a type of wedging can be achieved between the electrical contacts 9 to 12 and between the wires in the lamp carrier 28.

FIG. 12 shows a simplified plan view illustration of an example of the luminaire 27.

In this regard, the lamp carrier 28 is shown, wherein the lines 36 and 37 are arranged so as to run parallel and so as to be incorporated in the lamp carrier 28. In the exemplary embodiment, a distance a1 is formed which is 123.5 mm.

Furthermore, the outer diameter d3 of the lamp 1 is shown, which is 120 mm, for example. Furthermore, insertion slots 32a and 32b are shown, wherein the insertion slot 32a for the electrical contacts 9 and 10 and the opposite contacts 11 and 12 is shown in accordance with the embodiments in FIG. 8. The insertion slot 32b, on the other hand, is provided for the locking element 38, with the result that an angle between the two elements of 45° is formed in this case too.

Corresponding insertion slots are also in each case formed on the opposite side, with the result that the opposite electrical contacts 11 and 12 and the opposite locking element 39 can also be introduced correspondingly there.

Furthermore, a diameter d5 is illustrated which indicates the inner diameter of the cutout 31, which is 121 mm in the embodiments. It is therefore only 1 mm greater than the outer diameter d3 of the lamp 1.

Furthermore, a diameter d6 is illustrated which represents the inner diameter of the movement zone in the lamp carrier 28. This means that, in various embodiments, the movement zone therefore extends over the region in which the locking elements 38 and 39 and the electrical contacts 9 to 12 can be accommodated or can move and is defined thereby. The movement region is therefore a hollow cylinder, which adjoins the cutout 31 and otherwise extends into the interior of the lamp carrier 28 without advancing as far as the surfaces thereof. This diameter d6 is therefore 5 mm greater than the diameter d5 and 6 mm greater than the outer diameter d3 of the lamp 1.

Furthermore, a latching zone or locking zone 43 is shown, into which the locking element 38, which has been introduced into the insertion slot 32b or the recess, latches when the lamp 1 is introduced into the lamp carrier 28 in the end position thereof. This means that, once the lamp 1 has been inserted by being sunk in and therefore moving along the longitudinal axis A of the lamp 1, which longitudinal axis A extends perpendicular to the plane in the figure, and therefore the locking element 38 has been introduced into the insertion slot 32b and the electrical contact 9 and/or 10 has been introduced into the insertion slot 32a and the lamp 1 has subsequently been rotated about the axis A in the clockwise direction through 90°, the locking element 38 is latched in this locking zone 43. In this position of the final installed position, the electrical contact 9 and/or 10 has then reached the contact-making position 44, in which it makes electrical contact with the line 36 and, in this regard, therefore stands virtually perpendicular thereto. In various embodiments, provision is made for the locking zone 43 to be designed to be open at the top and bottom. As a result, a locking element 38 can snap out of the locking zone 43 in the latched-in end position at the top and bottom if the lamp 1 is rotated about an axis of rotation, which is in the plane of the figure and which runs through the center point and the electrical contacts of the lamp 1, or is tilted relative to the lamp carrier 28. The tilting can then be performed out of the plane of the figure.

The same applies to the electrical contacts 11 and/or 12 and the locking element 39, wherein in this regard a corresponding locking zone (not shown) is formed on the opposite side of the locking zone 43 and, in respect of the contact with the line 36, a contact-making point 45 which is opposite the contact-making point 44 is formed.

FIG. 13 provides a further plan view illustration of various embodiments of a luminaire 27, wherein in this regard the luminaire 27 is circular. It also includes a lamp carrier 28 assembled from two plates 29 and 30, wherein a plurality of flat lamps in the form of circular disks and in the form of lamps 1a, 1b, 1c, 1d, 1e, 1f, 1g and 1h are formed in this lamp carrier 28. The number and arrangement of the lamps 1a to 1h is merely exemplary. All of the lamps 1a to 1h are in the form of flat lamps. At least one of the lamps 1a to 1h can be formed with a light-emitting diode as light source. At least one lamp 1a to 1h can furthermore be formed with a halogen light source. Furthermore, provision can be made for at least one lamp 1a to 1h to be in the form of a discharge lamp. Therefore, the luminaire 27 can have at least two different lamp types and be equipped correspondingly.

It can be seen that the lamps 1a, 1b, 1e and 1g are arranged equidistantly with respect to one another in the circumferential direction in an outer circular ring, and the lamps 1c, 1d, 1f and 1h are likewise arranged equidistantly with respect to one another in an inner circular ring. The lamps 1a, 1b, 1e and 1g are each arranged with an offset of 45° with respect to an adjacent lamp in the inner circle segment.

Lines are laid in the form of a circle in the lamp carrier 28, wherein two lines 46 and 47 are lines of a first polarity and one line 48 has a second polarity. Each lamp 1a to 1h is therefore in contact with two lines 46 to 48 of different polarity.

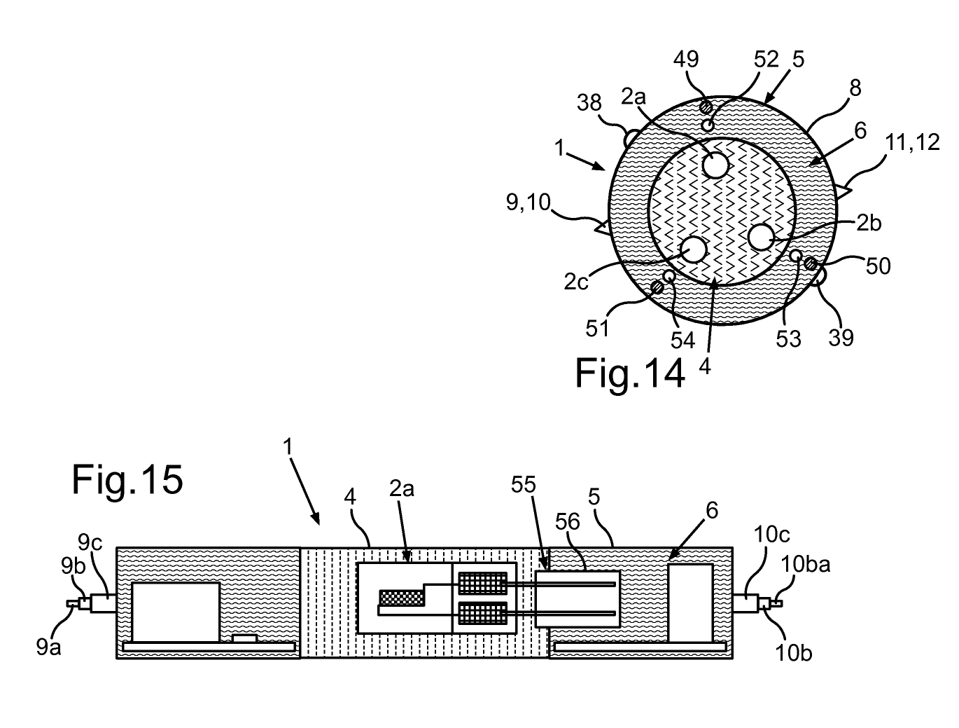

FIG. 14 shows a schematic plan view of various embodiments of a lamp 1. Said lamp is equipped with three light sources 2a, 2b and 2c, for example. The light sources 2a to 2c are in the form of halogen light sources, with the result that the lamp 1 is a halogen lamp. In various embodiments, the light sources 2a to 2c are arranged detachably and can therefore be withdrawn easily and inserted again. For this purpose, fittings are formed in the second housing part 4.

Furthermore, provision is made for each light source 2a to 2c to have a dedicated optical indicator element 49, 50 and 51, wherein the indicator elements 49 to 51 are light sources, in particular light-emitting diode lamps. The optical indicator elements 49 to 51 indicate a functional or operating fault in the associated light source 2a to 2c.

As can be seen from the illustration in FIG. 14, these indicator elements 49 to 51 are arranged in the first housing part 5 on a corresponding circuit carrier. In various embodiments, they are arranged on the circuit carrier on which the electronic component parts of the operating device 6 are also arranged. Furthermore, reset buttons 52, 53 and 54 for fuses are arranged adjacent to the optical indicator elements 49 to 51.

In various embodiments, the light sources 2a to 2c are connected in series.

The operating voltage of the lamp 1 is 230V. The light sources 2a to 2c are preferably designed as 77V light sources and are connected in series. Provision may also be made for the light sources to be designed for a rated operating voltage of 12V and for the operating device to be formed without a transformer. In this case, the lamp 1 is supplied an SELV voltage of 60V, and five halogen light sources with a rated voltage of 12V are connected in series.

The light sources 2a to 2c are furthermore e.g. also in the form of pin base lamps, for example lamps with a G9 base. Furthermore, they may have an IR-reflecting coating. The housing parts 4 and/or 5 consist at least partially of a thermally stable material, for example LCP or PPS, in the inner region of the module. In this region, receptacles, for example for fixing a reflector or reflectors, can preferably also be provided. A reflector is preferably adjustable in the direction of the lamp axis, which extends perpendicular to the plane of the figure, as a result of which adjustment and optimization of the imaging ratios is enabled. In various embodiments, this adjustment takes place via a screw thread at the end of the reflector.

As already mentioned, the reset buttons 52 to 54 for the fuses are integrated in the operating device 6. As a result, it is also possible to use lamps with solid holding elements without a lamp-side fuse. In various embodiments, the lamp fuses are electronic and can be reset by these buttons 52 to 54, as a result of which it is not necessary for the fuse to be replaced in the event of a lamp failure.

In various embodiments, the indicator elements 49 to 51 are LED light sources, which only respond when the mains voltage is present at a light source 2a to 2c. Furthermore, balancing of the power consumption in a series circuit including the light sources 2a to 2c may be provided.

FIG. 15 shows a schematic sectional illustration of various embodiments of a lamp shown in FIG. 14, which is in the form of a halogen lamp. In these embodiments, provision is made for the light source 2a to extend in the plane of the lamp and therefore not to protrude beyond the physical height at the top or bottom. In a preferred form, the lamp has an integrated reflector, as is offered for sale, for example, by the applicant under the designation Ministar. Contact can be made between the lamp and the mains line via the contact 9a, 9b, 9c in the form of a twin contact, in a similar way to as in FIG. 10a. However, provision can also be made for only a low voltage of 60V to be supplied to said lamp.

Furthermore, provision is made for a second contact 10a, 10b, 10c, which is likewise in the form of a pin-like twin contact, to be brought into contact with protective earth and a control line, which conducts 230V, or with two control lines, which conduct 60V DC. In various embodiments, in a low-voltage embodiment, provision can be made for the electronic operating device to be divided into two operating device parts, and for only one operating device part with the associated corresponding electronic component parts being arranged in such a way as to be integrated in the lamp 1, and the other operating device part being arranged externally with respect to the lamp and spaced apart therefrom.

Furthermore, a fitting 56 for the light source 2a is provided, which is fixed to a fixing 55.

FIG. 16 shows a schematic plan view illustration of part of a lamp carrier 28, wherein, corresponding to the adjacent illustration in FIG. 17, a side view of the lamp carrier 28 with the upper plate 29 and the lower plate 30 is illustrated. In both plates, a plurality of cutouts 31 are formed, wherein flat lamps with a circular geometry can then be introduced into said cutouts. In the exemplary embodiment, the two plates 29 and 30 are designed to have the same dimensions and are formed from polymer, in particular acrylic glass. The two plates 29 and 30 have a length of 800 mm in the x direction in the embodiments and a width of 200 mm in the z direction. The cutouts 31 are designed corresponding to the illustration in FIG. 12 in terms of their detail configuration. In various embodiments, they have a diameter d6 of 126 mm as shown in FIG. 12 in the various embodiments.

In order to produce a luminaire 27, in accordance with various embodiments, the two plates 29 and 30 are therefore first provided and the cutouts 31 in the form of holes are introduced or the plates 29 and 30 have already been cast with the holes in this way. Furthermore, in accordance with the schematic illustration, flutes or troughs or depressions 57 and 58 are formed in the opposite sides of the cutouts 31, and then the lines 36 and 37, which are arranged on opposite sides with respect to a cutout 31 in various embodiments, and/or the line 40 are introduced into said flutes or troughs or depressions.

In accordance with various embodiments as shown in the plan view illustration in FIG. 18, pot-shaped lampholders 59, 60, 61 and 62 are then introduced, said lampholders then being designed for accommodating the corresponding lamp 1. The lampholders 59 to 62 have, in integrated form, the insertion slots, undercut zones, grooves, locking zones and contact positions already explained above in relation to FIG. 7 to FIG. 12. This is indicated schematically in the illustration in FIG. 18.

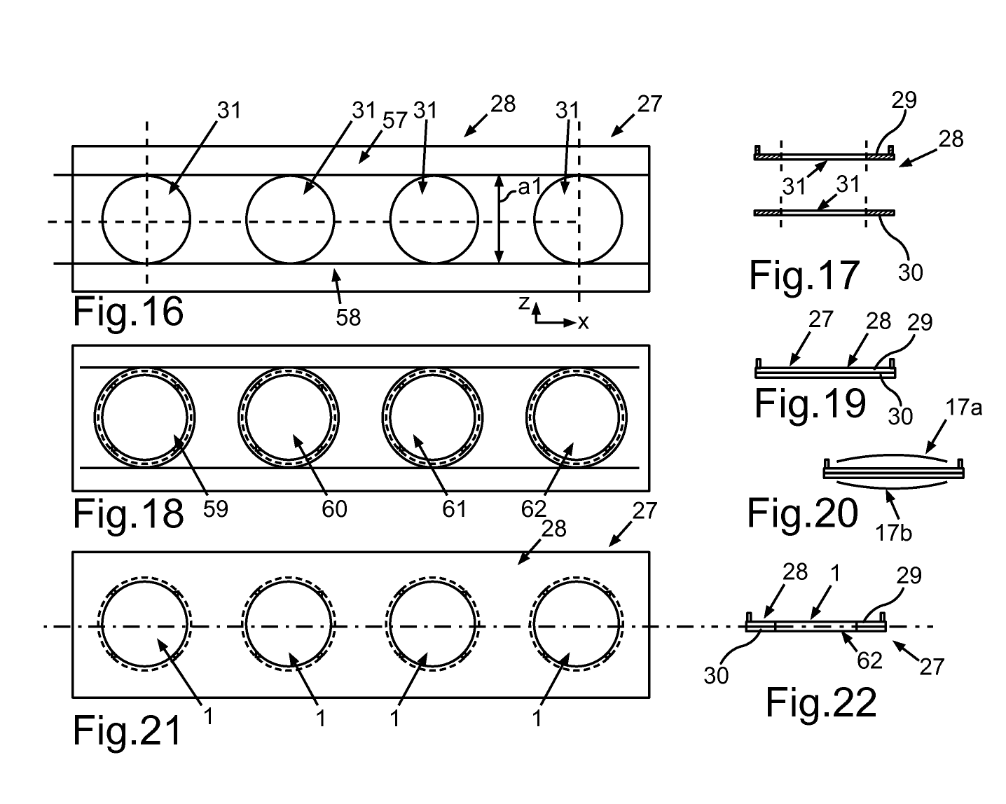

In a further method step, the upper plate 29 is then connected to the lower plate 30 in accordance with the side view shown in FIG. 19. In various embodiments, for this purpose provision is made for, in this regard, a mechanical coupling connection, such as a clip-like connection, a latching connection or else a dovetail-like connection, for example, is provided. For this purpose, e.g. corresponding connecting elements can be provided on the lampholders 59 to 62.

In the further lateral schematic illustration shown in FIG. 20, provision can furthermore then also be made for light-directing or light-forming elements such as, for example, one or more reflectors, one or more scattering disks or else a grid or a convection-limiting diaphragm 17a and 17b to be formed on the upper side and/or the lower side. The attachment and fitting of the elements 17a and 17b can be performed in different phases of the production of the luminaire 27 or else not until at the customer's end.

In FIG. 21, subsequent to the production stage shown in FIG. 18 and FIG. 19, in each case one lamp 1 is then inserted into one of the lampholders 59 to 62. In this regard, the insertion is performed in a similar way to the explanation in FIG. 12, with the result that the lamps 1 are brought into their installed position in their lampholders 59 to 62 by being inserted and rotated and then latched there. The locking elements and electrical contacts are in this case finally arranged respectively on their corresponding locking zones and contact points.

The luminaire 27 can be designed to accommodate a plurality of lamps 1 of the same lamp type, but also to accommodate lamps of different lamp types. In respect of the configuration of different lamp types, the lamps 1 can be designed corresponding to the specific types already explained above a number of times.

FIG. 22 shows a schematic sectional illustration, in which the finally assembled luminaire 27 is shown. The figure also shows the suspension systems which are not characterized in any more detail, which protrude upwards at the sides and which are e.g. fixed to the end pieces (not described) of the upper plate of the lamp carrier.

Provision may be made for the fitting of reflectors 17a and 17b and/or grids and/or diaphragms and/or further cooling elements to be performed after the production stage as was reached in FIG. 21. In this regard, it is then also possible for the convection-limiting elements and/or contamination prevention elements and/or possibly also further glare reduction elements to be fitted and attached. This variability makes it possible for the customer to configure his luminaire individually and to match it to different lighting tasks which result from a relocation, for example.

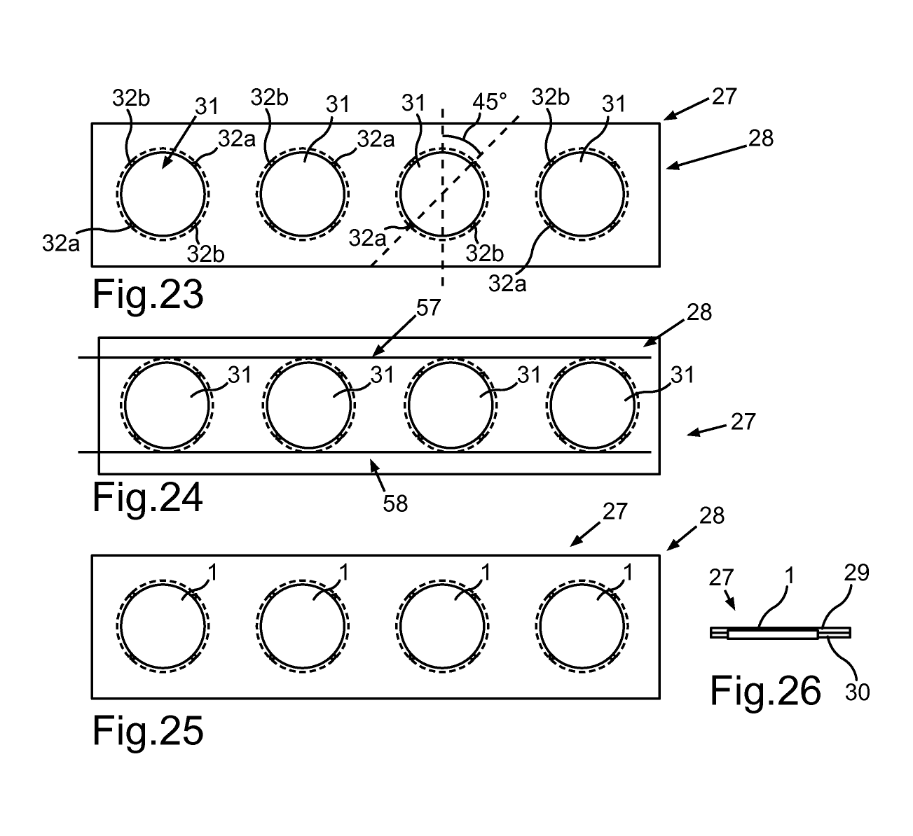

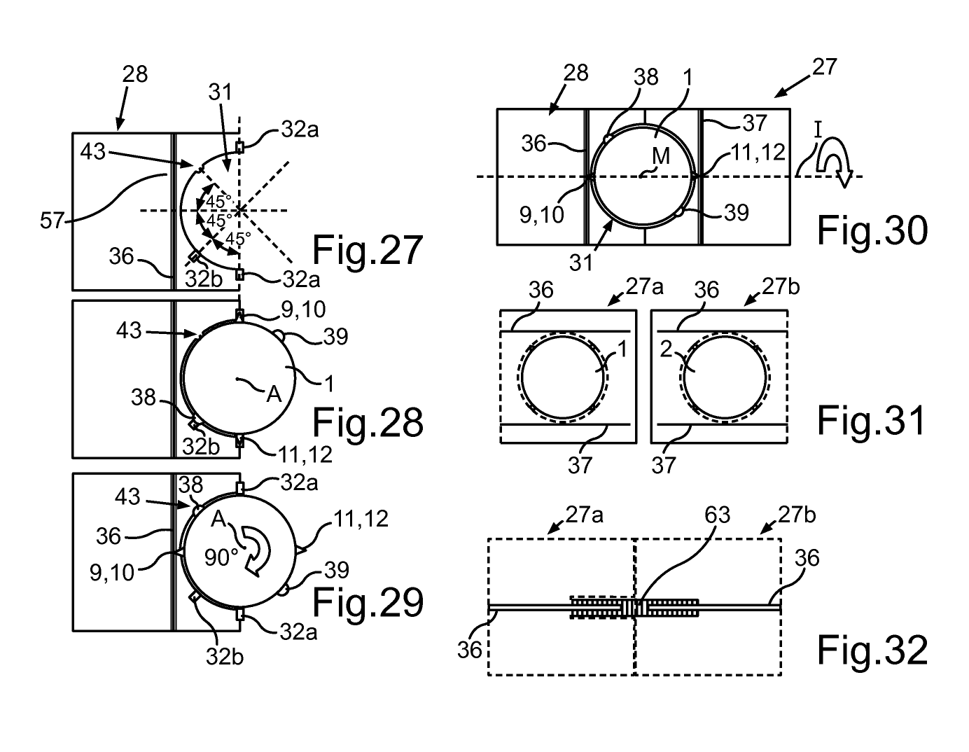

FIG. 23 shows a further plan view illustration of a lamp carrier 28 of a luminaire 27, wherein, in this regard, a variant of a production method of the luminaire 27 is explained, in contrast to the configuration in FIG. 17 to FIG. 23. In this case too, two plates 29 and 30 (FIG. 27) are provided by way of example. The plates are dimensioned and provided correspondingly, and in turn cutouts 31 are introduced into the two plates 29 and 30, said cutouts having a diameter of d5=221 mm, as in FIG. 12. In a subsequent method step, the circular undercut zones with a diameter of d6=126 mm and a depth of 2.4 mm are incorporated on the inner side of the plates 29 and 30. Thereupon, recesses are then produced peripherally with respect to these cutouts 31, said recesses then representing the insertion slots 32a and 32b for the electrical contacts 9 to 12, on the one hand, and for the locking elements 38 and 39, on the other hand. As can already be seen from the illustrations in FIG. 7 and FIG. 11 and in FIG. 8, said recesses are introduced only with such a depth that they reach only as far as the undercut zones 33 introduced on the other side of the plate.

Thereafter, in accordance with the plan view illustration in FIG. 24, the depressions or grooves 57 and 58 are then produced, and the corresponding lines are introduced therein. In a further step, the two plates 29 and 30 are then connected, wherein in this case, for example, an adhesive bond, a screw-type connection, a clip-type connection, a latching connection or another bolt connection or the like can be provided.

In accordance with the further production stage, in the plan view illustration shown in FIG. 25 the lamps 1 are then inserted into the cutouts 31. This takes place directly without the formation of lampholders 59 to 62, as was performed in the embodiments shown in FIG. 16 to FIG. 22.

The further statements relating to the operation of introducing the lamps 1 and the possibility of attaching reflectors and further additional elements and components are similar to the explanation relating to the procedure for producing the luminaire 27 shown in FIG. 16 to FIG. 22, and reference is made to the explanations given in this regard in respect of the embodiment of the production shown in FIG. 23 to FIG. 26. FIG. 26 shows a schematic sectional illustration of the fitting stage or production stage of the luminaire 27, as was reached in FIG. 25.

FIG. 27 to FIG. 29 show plan view illustrations of subcomponents of a luminaire 27 in different stages of the production method. The insertion of the lamp is once again explained here, as has already been explained in relation to FIG. 12, for example. Starting from the illustration in FIG. 27, in which the lamp carrier 28 is fitted in a form which is ready for insertion of a lamp 1, the lamp 1 is then inserted perpendicular to the plane of the figure and therefore along its longitudinal axis A in accordance with the illustration in FIG. 28, wherein this takes place in such a way that the electrical contacts 9, 10 or, if there is only one twin contact in accordance with a contact 9, this contact is inserted into the insertion slot 32b, wherein the contacts 11, 12 or, if there is only one contact 11, this contact is inserted into the opposite insertion slot 32a, on the opposite side. At the same time, the locking element 38 is inserted into the insertion slot 32b, and the locking element 39 is formed on the opposite insertion slot 32b (not illustrated). The insertion slots 32a and 32b represent recesses which are peripheral with respect to the cutout 31.

If an introduction of this kind is achieved in accordance with the illustration in FIG. 28, a rotation about the axis A shown in the illustration in FIG. 30 through 90° is then performed in the clockwise direction, with the result that the locking element 38 is then latched into the locking zone 43, with the optionally opposite locking element 39 latching into a corresponding locking zone. Furthermore, the electrical contacts 9 and 10 and 11 and 12 make contact with the provided lines 36 and 37 and with ground potential and with a control line 40, as has already been explained.

FIG. 30 shows a plan view of a luminaire 27, in which a lamp 1 in the completely fitted end state and therefore in the final installed position is arranged in the lamp carrier 28. An axis of rotation I is shown, which runs through the center point M of the lamp 1 and furthermore also through the contacts 9 to 12.

The luminaire 27 is arranged so as to be capable of rotating about this axis of rotation I and can be pivoted correspondingly, wherein for this purpose the contacts are in the form of twin contacts and contact pins.

Provision can also be made for the lamp 1 to be capable of rotating about this axis of rotation I relative to the lamp carrier 28. In this case, the contacts are arranged as double pins, which are in the axis of rotation.

FIG. 31 shows a plan view illustration of a first light-emitting module or a first luminaire 27a and a second light-emitting module or a second luminaire 27b, which each have at least one lamp 1. The luminaires 27a and 27b are designed corresponding to the previously explained configurations or can be designed so as to correspond to subfeatures.

FIG. 31 shows the two luminaires 27a and 27b separated from one another. They can be connected to one another retentively, which is shown in FIG. 32, as a result of which a light-emitting system is formed. Said figure shows a schematic sectional illustration, in which said light-emitting system is shown in the region of a line 36. In this image shown in FIG. 32, a connecting sleeve 63 is formed which makes contact between the two mains lines 36 of the individual modules 27a and 27b and connects them electrically to one another. There is a corresponding design for the two lines 37 and the line for the grounding and signal transmission. Furthermore, the lamp carriers 28 can be connected retentively to one another by plug-type connections or latching connections or the like.

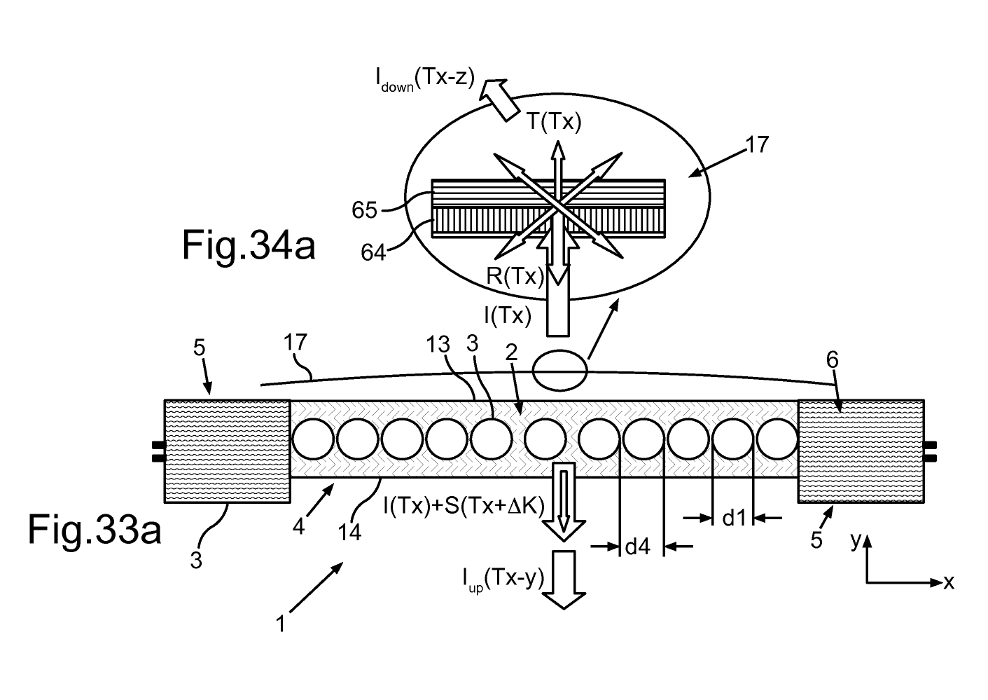

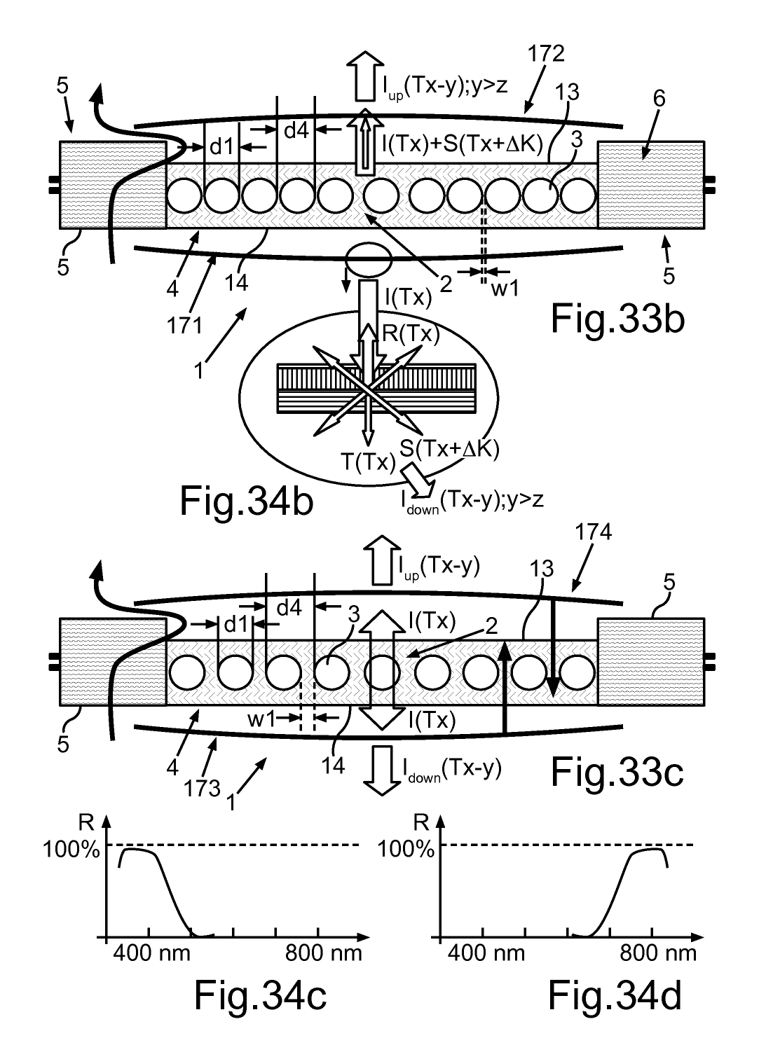

FIG. 33a shows the lamp 1 shown in the illustration in FIG. 1, wherein, furthermore, in addition a reflector 17 is arranged on that front side of the second housing part 4 which faces the front side 13 and is spaced apart therefrom.

The following nomenclature applies for FIGS. 33a to 33c and 34a to 34d:

Tₓ the color of light of the light source;

R reflectivity of the reflector 17, 171 . . . 174, which can also be wavelength-selective, such as in FIGS. 34c and 34d, for example;

S(Tₓ-ΔK) function in accordance with which the reflector 17, 171 . . . 174 scatters and/or converts light;

ΔK color shift, which is realized by the conversion of phosphor, which can be admixed to the carrier 64, for example, in the lower (I_{down}) or upper (Iᵤₚ) half-space;

T_{x±Z} color of the upwardly emitted light; NB: a positive z can only be realized in the case of FIG. 33c using dichroic mirrors;

T_{x-y} color of the downwardly emitted light;

Iᵤₚ intensity of the upwardly emitted light with color temperature T_{x±Z};

I_{down} intensity of the downwardly emitted light with color temperature T_{x-y}.

The reflector 17 in FIG. 33a is designed to the extent that the light from the light source 2 which represents the single light source makes it possible to split the emission into the upper (Iᵤₚ) and lower (I_{down}) half-space, with this proportionate emission being freely adjustable.

In the example shown in FIG. 33a, it is only possible to direct cold light downwards and warm light upwards.

Furthermore, the reflector 17 is designed to scatter the light, to reflect the light for photocatalysis and for color conversion of the light emitted by the light source 2 and for limiting convection and as a dirt trap.

The reflector 17 therefore provides the possibility of a color shift through AK in e.g. one of the two emission directions. This is expedient, for example, in applications where a daylight-like light color is intended to be illuminated on to a (white) ceiling and the (darker) floor is intended to appear to have a warmer light color. This results in advantages when illuminating high rooms with suspended luminaires without the requirement for a false ceiling. This is realized e.g. in the embodiments shown in FIGS. 33c and 34c/d. By virtue of the possibility of additional light scattering, the glare effect is reduced and the luminance of the light source is made more uniform. Furthermore, efficient air purification by virtue of photocatalytic reactions of the coating of the reflector 17 in conjunction with UVA radiation from the lamp 1 is achieved.

In the embodiments shown in FIG. 33a, the reflector 17 in accordance with the enlarged illustration in FIG. 34a (detail of the reflector 17) has a carrier 64, which is formed from polymer or glass. Provision may be made for the carrier 64 to be formed from two different light-transparent polymers, for example PC and PMMA, which have different refractive indices. As a result, the intrinsic scattering effect is intensified.

The carrier 64 is coated with an at least partially reflective layer 65. A coating 65 can be formed on that side of the carrier 64 which faces the light source 2 and/or on that side of the carrier 64 which is remote from the light source 2. The carrier 64 has a transmittance T and a scattering effect S. It is also possible for color-converting phosphor particles to be admixed to the carrier material, which results in color conversion and therefore in a temperature shift predominantly of the light emitted in the negative y direction in the image. The at least partially reflective layer 65 has a reflectance R. The reflector 17 is in the form of an at least partially mirror-coated reflector 17 with a reflection factor R. As is shown in the exemplary embodiment, the layer 65 is applied to that side of the reflector 17 which is remote from the light source 2 and therefore also from the lamp 1. Reflection therefore only takes place after transmission of the light through the carrier 64.

Depending on the magnitude of the reflectance R and the transmittance T, the light is either virtually completely reflected or virtually completely transmitted. In this regard, it is possible to achieve degeneration of the reflector 17 with respect to the cover disk.

By virtue of the reflector 17 or the light-guiding element being in the form of convection limiters, lamps 1, as have been described above, can also be used in very cold environments, such as in cold stores, for example.

The reflective layer 65 can also be formed as a nonmetallic reflective layer consisting of an inorganic material with high reflectance in the visible spectral range, said material in this case being applied as a layer to that side of the carrier 64 which faces the light source 2. In various embodiments, the layer 65 includes, as an admixture, TiO₂, which, in conjunction with UVA radiation, enables photocatalytic decomposition reactions of organic vapors, which result in the formation of CO₂, water and hydrates. As a result, air purification can be achieved. The photocatalytic reaction is enabled without the generation of negative ions. Owing to the convection, the air comes into contact with the material TiO₂ when the housing parts 4 and/or 5 are at least partially open. The coating with TiO₂ may be formed on that side of the carrier 64 which faces the light source 2.

In various embodiments, scattering bodies which are at least proportionately phosphor are admixed to the material of the plate-like carrier 64. The phosphor introduced may be one which leads to conversion of blue light into longer-wavelength light, for example into the green-red spectral range with a temperature shift of the light emitted in the negative y direction. In various embodiments, the phosphor is of the type YAG:Ce, in various embodiments the phosphor L 175.

The grain structure of the phosphor may be in the range of greater than one micrometer and less than 50 micrometers.

Provision may be made for the phosphor to be applied as an additional layer to that side of the reflector 17 which faces the light source 2. It may also be that the phosphor may be introduced in the granules of the polymer of the plate-like carrier 64.

In the embodiments shown in FIG. 33b, two reflector elements 171 and 172 are formed. One reflector element 172 is arranged facing the upper side 13, and the other reflector element 171 is arranged facing the lower side 14. In accordance with the enlarged illustration in FIG. 34b, the lower reflector element 171 is formed with a layer 65, which is a color conversion layer. A wavelength-selective coating is in this case not formed. The layer 65 is formed on that side of the carrier 64 which is remote from the lower side 14. A coating with TiO₂ is provided on that side of the carrier 64 which faces the lower side 14. The illustration in FIG. 34b is therefore practically inverted with respect to the illustration in FIG. 34a. In various embodiments, the upper reflector element 172 does not have a color conversion layer. It may have a wavelength-selective coating and e.g. a coating with TiO₂ is provided at least in the peripheral regions which extend over the first housing part 5.

A correspondingly locally specified application of the coating with TiO₂ may be provided on the reflector element 171 and on the reflector 17 in FIG. 33a.

In the embodiments in FIGS. 33b and 33c, it is possible to freely adjust luminous fluxes towards the top and bottom and therefore emission directions provided in the positive and negative y direction within a range of between 0% and 100% of the lamp luminous flux.

In the embodiment shown in FIG. 33b, provision may be made for an optically dense helix of the discharge vessel 3 to be formed. A small pitch w1=d4/d1 of the helix therefore may be provided. Furthermore, the following may be provided:
in order to realize air purification, the flow runs partially through the first housing part 5;
the intermediate wall 7 between the first and the second housing parts 5 and 4, respectively, is not required;
reflector element 172 is transparent with a thin nano-TiO₂ layer;
the light which is reflected upwards is colder (bluer) than that which is reflected downwards (desired).

If the color difference between Iup and Idown is intended to be great, the following conditions need to be met:

1. Tₓ should be as high as possible and as close as possible to the target value T_{x-z}.

2. y-z should be high, for example higher than 1000K, preferably higher than 2000K.

3. ΔK should be as high as possible, i.e. the conversion phosphor should convert as much blue content as possible from Tₓ into longer-wavelength light with the color temperature Tₓ-ΔK.

4. In order to minimize z, provision needs to be made for the largest proportion of S(Tₓ-ΔK) to pass into I_{down} and for the amount in Iᵤₚ to be kept low. For this purpose, the distance between the turns w1=D−d of the helix needs to be kept as small as possible since the helix for S(Tₓ-ΔK) therefore becomes optically denser.

FIG. 33c shows an example in which two reflector elements 173 and 174 are formed. In contrast to the configuration shown in FIG. 33b, in this case there is no color conversion layer, but a wavelength-selective coating formed in both reflector elements 173 and 174. The reflector elements 173 and 174 are therefore dielectric mirrors. FIGS. 34c and 34d show the reflectivity of the mirrors. FIG. 34c relates to the reflector element 174, and FIG. 34d relates to the reflector element 173.

The magnitude of the color shift AK can be adjusted virtually as desired via the position and width of the edge filter. In order not to excessively negatively influence the color rendering index, the profile of the reflection edge should tend to be more flat, i.e. should cover a wide wavelength range and the maximum reflectance should not exceed 90%.

The distance w1 is in this case greater than in the embodiment in FIG. 33b and may be between 0.5 d1 and d1, e.g. 0.75 d1.

In various embodiments, provision is made in the embodiments in FIGS. 33a to 33c for the discharge vessel 3 to be coated on the inside with a phosphor layer, with the layer thickness being varied. In various embodiments, provision is made for this phosphor layer to be thicker on the side facing the reflector 17 than on the side remote from the reflector 17.

It is noted that a reflector 17, 171 to 174 is freely adjustable by virtue of the design of the individual reflector properties of reflection, transmission, scattering properties, filter properties, convection limitation properties and photocatalytic properties for each of the reflectors shown in FIGS. 33a to 33c. By virtue of the possibility described further above of a mechanical connection between the reflector and the first housing part 5 which is reversibly detachable, the possibility thus results of an application-specific configuration of the lamp 1 in the luminaire 27 on the part of the operator corresponding to the lighting tasks to be solved.

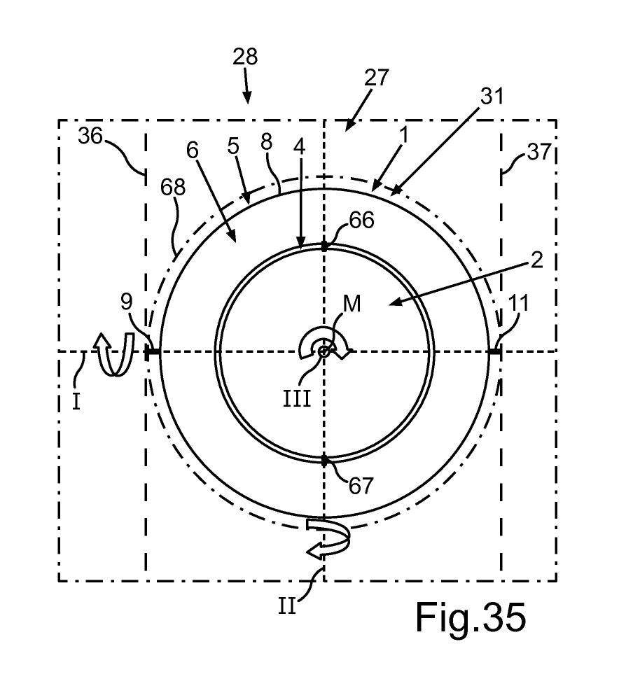

FIG. 35 shows a schematic plan view of a luminaire 27. The luminaire 27 is designed so as to correspond to the statements relating to the previous figures, wherein, in this regard, it has the plate-like lamp carrier 28 and at least one lamp 1, which is arranged in a cutout 31. The lamp 1 in the form of a flat lamp is in the form of a flat cylinder and is therefore virtually disk-shaped in the plan view illustration. In various embodiments, provision is made for the lamp 1 to have two mutually opposite electrical contact pins 9 and 11, which lie on a straight line through the center point M of the lamp 1.

The contact pins 9 and 11 are in the form of twin contacts, as has already been explained above. The lamp 1 can be rotated relative to the lamp carrier 28 about these contact pins 9 and 11 and a first axis of rotation I. Provision is furthermore made for the lamp 1 to be constructed in such a way that the second housing part 4 with the light source 2 is formed separately from the second housing part 5 with the electronic operating device 6. In this regard, further electrical contact pins 66 and 67 are formed on opposite sides of the second housing part 4, wherein these contact pins 66 and 67 also lie on a straight line through the center point M and are e.g. in the form of twin contacts. This straight line runs perpendicular to the straight line through the contact pins 9 and 11. In the embodiments, provision is made for, therefore, the second housing part 4 of the light source 2 to be capable of rotating about a second axis of rotation II, which runs perpendicular to the first axis of rotation I. In this regard, therefore, the second housing part 4 is capable of rotating relative to the first housing part 5 about this second axis of rotation II.

Furthermore, provision is made for a third axis of rotation III to be provided, which runs perpendicular to the plane of the figure and perpendicular to the first and second axes of rotation I and II. Lamp 1 is also capable of rotating relative to the lamp carrier 28 about this third axis of rotation III. In this regard, provision can be made for the entire lamp 1 to be capable of rotating relative to the lamp carrier 28 about this third axis of rotation III. However, provision can also be made for the lamp 1 to be constructed in such a way that the second housing part 4 can be rotated about this third axis of rotation III relative to the first housing part 5 of the lamp 1. The rotation about the third axis of rotation III is ensured when the contacts 9 and 11 and/or the contacts 66 and 67 are sliding contacts.

In addition to the mentioned lines 36 and 37, the dashed lines used to represent them also comprise the protective earth and the control line 40.

Furthermore, also by way of example here, the undercut zone is indicated by the reference symbol 68.

The electrical contacts 66 and 67 can likewise be in the form of twin contacts, with the contact assignment in this case being designed on the basis of lamp type. In the case of discharge lamps, for example, the electrode 1 is connected to the contact pair 66 and the electrode 2 is connected to the contact pair 67.

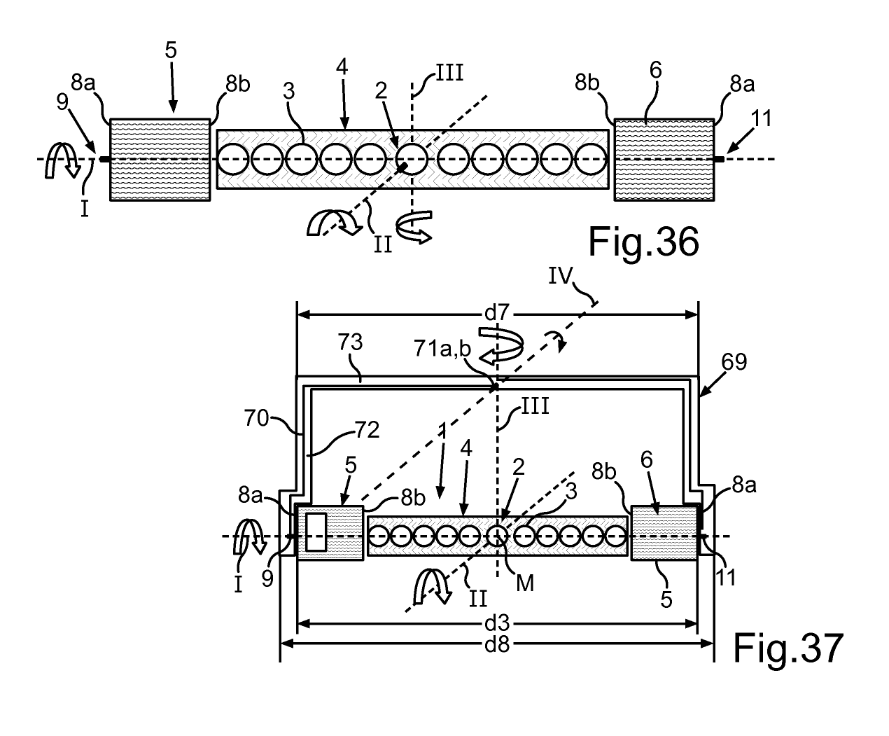

FIG. 36 shows a sectional illustration of the lamp 1 shown in FIG. 35, wherein, in this regard, it has been removed from the lamp carrier 28 of the luminaire 27 so as to simplify the illustration. In the embodiments shown, the lamp 1 is a discharge lamp. The first housing part 5 comprises a side wall 8 with an outer outer side 8a and an inner outer side 8b.

FIG. 37 shows various embodiments, in which the lamp 1 is arranged in an adapter 69 and is capable of rotating relative to the adapter 69 about the axis of rotation I if the contacts 9 and 11 are each two contact pins. Electrical lines 70 are integrated in the adapter 69, between the electrical contacts 9 to 12 in the form of contact pins and an electrical contact 71a and 71b, which is in the form of a double pin and is formed in the adapter 69. Said lines produce the electrical contact with respect to the luminaire or the fitting thereof. The adapter 69 comprises struts 72 and an extension adapter 73.

The adapter 69 has a diameter d7, wherein the adapter 69 surrounds the housing 5 and in this regard is expanded and has a diameter d8.

In various embodiments, the lines for the electrical connection are therefore integrated in the adapter 69. In various embodiments, the lines for the electrical connection of the contact pins are also integrated in the operating device 6 between the electronic operating device 6 and the lamp 1.

The extension arms of the adapter 69 are in the form of struts 72.

Furthermore, provision may be made for the adapter 69 to be capable of rotating about an axis IV and/or the axis III relative to a lamp carrier 28, on which the adapter 69 can be arranged. For the rotation about the axis III, the contacts 71a and 71b are in the form of sliding contacts.

If, in accordance with various embodiments, the contacts 9 to 12 are in the form of contact pins and the lamp 1 is formed in such a way that the housing part 5 is capable of rotating relative to the housing part 4, e.g. about the axis II, electrical contacts between the housing part 5 and the adapter 69 can be formed as sliding contacts.

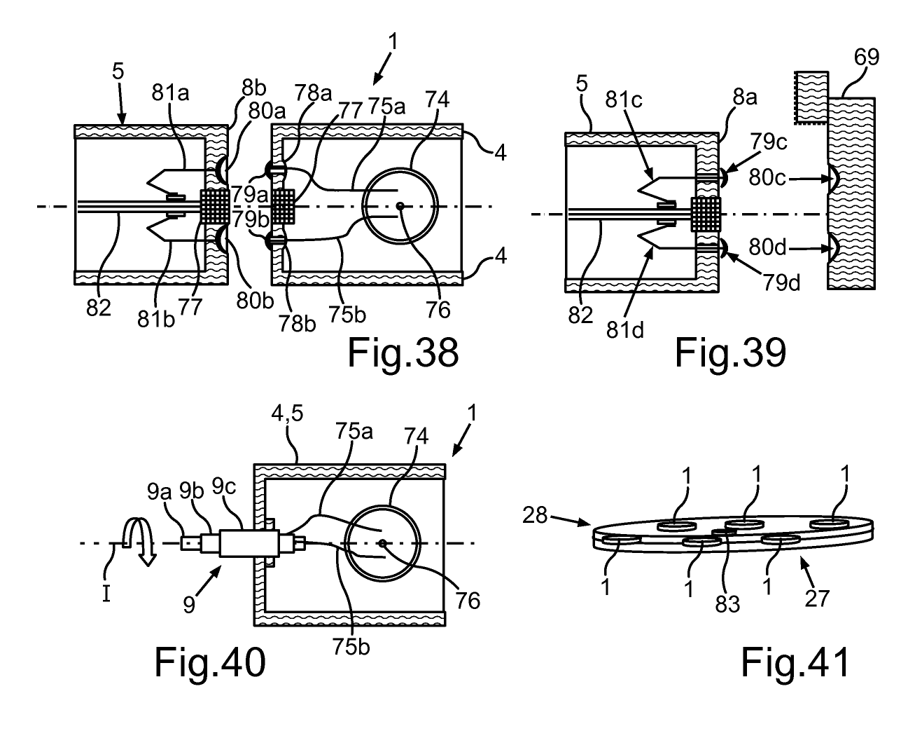

In this regard, reference is made to the explanations below relating to FIG. 38.

In various embodiments of the lamp 1, provision may be made for the contacts 9 and 11 to be sliding contacts instead of contact pins. This results in a variant with respect to the direction of rotation. In this case, the lamp 1 is not capable of rotating about the axis I, but about the axis of rotation III relative to the adapter 69. On the basis of the fact that, in this embodiment, the sliding contacts are arranged on the outer outer side 8a of the housing of the lamp 1, provision may then be made, when the lamp has two housing parts 4 and 5 capable of moving relative to one another, for the electrical contacts between the two housing parts 4 and 5 to be e.g. contact pins. As a result, the housing parts 4 and 5 may be rotated about the axis of rotation I or II relative to one another. with respect to the sliding contacts between the adapter 69 and the housing of the lamp 1, reference is made to the explanations below relating to FIG. 39.

In various embodiments, at least two, at most four, such struts 72 are formed. The contact system between the lamp 1 or the light source 2 and the housing part 5, which has at least subcomponents of the operating device 6, is preferably designed to be codable. This coding can be realized, for example, by the length and/or diameter of the electrical contacts being given different dimensions. This ensures that only lamps which are electrically compatible with the operating device 6 are connected to said operating device.

In various embodiments, the rotary movement about the axes of rotation I to III is performed via a motor-operated drive, which can be driven via remote control. The adapter 69 furthermore also allows for the lamp diameter to be adjusted. For example, the lamp 1 can have the same diameter as or a larger or smaller diameter than a corresponding lamp without an adapter 69.

FIG. 38 shows a schematic sectional illustration through a lamp 1, which in this case is a discharge lamp, in the region of a fuse seal. Said figure shows the lamp fuse seal 74, which in this case is in the form of a stem-tube fuse seal. 75a and 75 denote the power supply lines. Furthermore, an exhaust tube 76 is formed.

The entire housing of the lamp 1 is in turn constructed in two parts and may include a connecting region 77.

Furthermore, protrusions 78a and 78b with access points for making contact with the power supply lines are shown. Furthermore, a metallic coating, which is electrically conductively connected to the power supply lines 75a and 75b, is formed over part of the circumference of the housing, wherein, in this regard, e.g. four segments are provided, and electrical contacts 79a and 79b are formed as sliding contacts on the side wall of the second housing part 4. As a result, the relative rotatability between the housing part 4 and 5 about the axis III is provided as shown in FIG. 37.

The connecting regions 77 are formed mechanically and are provided for mechanically connecting the two housing halves of the housing parts 4 and 5.

Furthermore, contact elements 80a and 80b in the form of sliding contacts of the operating device 6 with integrated spring contacts 81a and 81b on the inner outer side 8b are formed in the first housing part 5. Furthermore, the circuit carrier 82 is shown. In the state in which contact is made, the contacts 79a and 79b engage in the contact elements 80a and 80b.

FIG. 39 shows a sectional illustration of a subregion between the adapter 69 and the first housing part 5. In this case too, electrical contacts 79c and 79d are formed as sliding contacts on the outer outer side 8a and make contact with the contact elements 80c and 80d in the form of mating sliding contacts and enable the rotatability of the housing part 5 relative to the adapter 69 about the axis III, which is the same as the longitudinal axis A of the lamp 1. Furthermore, integrated spring contacts 81c and 81d are also formed here.

In various embodiments, the ability of the lamp 1 to rotate about the axis III is possible when the mains lines and control lines are arranged in the form of a circle around the lamp 1 in the lamp carrier 28, as is indicated by way of example by the lines 68 in FIG. 36.

In various embodiments, the contacts on the side of the operating device or adapter have a convex surface with a specific radius. The electrically conductive connections on the circumference of the adapter 69 are e.g. provided in the angular range of ±85° about the axis of rotation III, with the result that a rotational range of 170° is provided.

In various embodiments, the first housing part 5 has concave mating pieces with a likewise specified radius, which is smaller than the radius of the convex adapter-side contacts, corresponding to the adapter-side, convex protrusions. In various embodiments, in this regard, the ratio between the radius of the convex surface of the adapter-side contact and the concave mating piece on sides of the first housing part 5 is in a range of greater than 1.01 and less than 1.2. As a result, a secure electrical and mechanical connection can be provided. In various embodiments, the insertion of the lamp 1 into the adapter 69 takes place by it being inserted from below, with the convex protrusions on the side of the operating device latching into the concave cavities in the adapter 69 and then being capable of rotating.

FIG. 40 shows a configuration of a lamp 1 which has the light source with a lamp fuse seal 74 and an exhaust tube 76 in a lamp housing 4, 5. The power supply lines 75a and 75b are connected to a contact 9 in the form of a twin contact. In this regard, reference is made to the statements in particular in relation to FIG. 10 in respect of the contact parts 9a and 9c and also the insulation 9b.

FIG. 41 shows a schematic perspective illustration of a luminaire 27, which has a disk-shaped lamp carrier 28 in which a plurality of lamps 1 in the form of disk-shaped flat lamps are arranged.

In the embodiments shown, the lamps 1 are all of a different lamp type, with the result that, in this regard, a low-pressure discharge lamp with an integrated ballast, an LED lamp and a halogen lamp as well as an OLED lamp are formed. In this regard, an electronic driver 83 is likewise integrated in the lamp carrier 28, which acts as a driver for the OLED lamp.

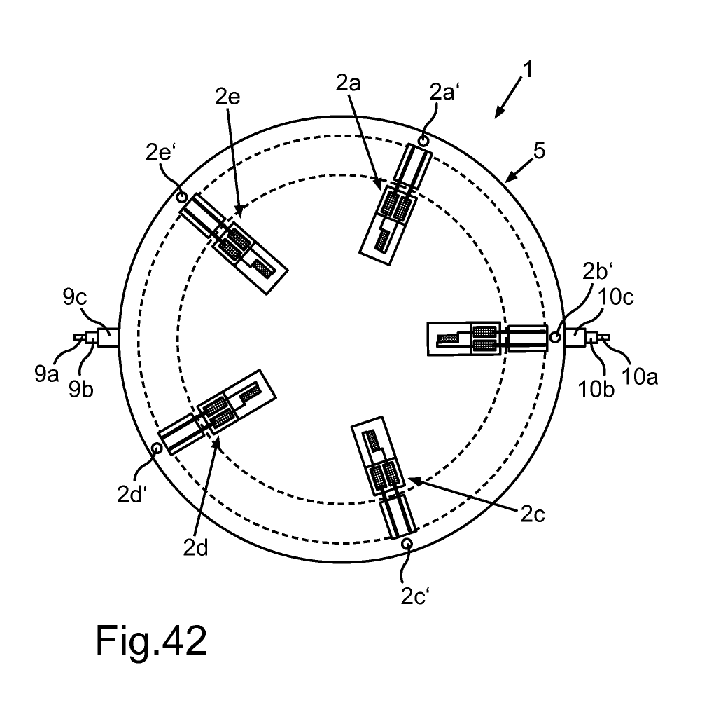

FIG. 42 shows various embodiments of a lamp 1 in a plan view. In various embodiments, the disk-shaped lamp 1 may include five light sources 2a to 2e, which are in the form of halogen light sources. The light sources 2a to 2e are e.g. arranged in such a way that they extend in the plane of the lamp 1 and therefore in the plane of the figure. The light sources 2a to 2e are designed for a rated operating voltage of 12V. They are connected in series and are supplied with a low voltage of 60V, as a result of which an SELV concept is formed. Contact pins, which are realized as twin contacts 9a, 9b, 9c and 10a, 10b, 10c, are formed on the outside of the first housing part 5. The twin contacts lie on a straight line through the center point of the lamp 1, with the result that it is also possible for the lamp to rotate about this straight line. Furthermore, a light-emitting diode 2a′ to 2e′ is arranged adjacent to each light source 2a to 2e, by virtue of which light-emitting diode a function indicator relating to the associated light source 2a to 2e is provided. In various embodiments, the electronic component parts of the light-emitting diodes 2a′ to 2e′ are arranged in the first housing part 5. Further component parts can preferably be arranged as a second operating device part in a third housing, which is fixed on a ceiling, for example, in such a way as to be spaced apart from the first housing part 5. Signal lines which can conduct the low voltage are laid between the first housing part 5 and the third housing and can at the same time also be used as suspension cables for the lamp 1. Provision can also be made for the lamp 1 to be formed without any component parts of the electronic operating device and for the operating device to be arranged completely externally with respect to the lamp 1.

The lamp can also be in the form of a flat lamp, in which a base is formed behind a light source, said base having contacts, for example contact pins. A housing is formed circumferentially around the base and behind the light source, and electronic component parts of an electronic operating device are arranged in said housing. This means that, when viewed in the direction of the longitudinal axis of the lamp, a housing part surrounding a base is formed behind the at least one light source, with the electronic component parts being arranged in said housing part. In various embodiments, this housing part is in the form of a ring, and the lamp is in the form of a flat cylinder and is therefore disk-shaped. In contrast to the configuration shown in FIG. 1, therefore, the component parts of the operating device 6 are therefore not arranged on a housing surrounding the light source, but behind the light source, and therefore make it possible to reduce the width of the lamp, wherein, in comparison with the configuration shown in FIG. 1, the height of the lamp is then slightly increased, however. In a configuration as a discharge lamp, therefore, in contrast to the configuration shown in FIG. 1, the component parts of the operating device 6 are then not arranged in a ring-shaped housing, which surrounds the discharge vessel 3 circumferentially, but behind the discharge vessel 3, which surrounds a base in the form of a ring. In various embodiments, the housing of the lamp 1 is constructed in such a way that it has the same diameter in the region of the discharge vessel as the ring-shaped housing part, which accommodates the operating device 6.

Provision may also be made for the lamp to be formed without a base and to be designed for making direct contact with mains lines. Such a lamp in this case does not have a base which can be inserted into a fitting of a luminaire. This luminaire is therefore in this case realized with its lamp without a base/fitting construction. In various embodiments, such a lamp is constructed in such a way that all of the electronic component parts of the operating device 6 are arranged behind a light source, with the lamp likewise being in the form of a flat lamp. In various embodiments, to this end in the case of a discharge lamp the discharge vessel is designed to be flat and has a substantially smaller height than its width and depth extent. In various embodiments, the discharge vessel 3 extends in multiply wound fashion in one plane, and then the component parts of the operating device are arranged distributed over the entire area behind this discharge vessel. The electrical contacts can be in the form of flat contacts on the outer side of the housing, e.g. the rear side or the side wall, wherein, in this regard, the housing may be in the form of a flat cylinder. It is also possible for a plug with contact pins to be formed on the rear side, it being possible for direct contact to be made between said plug and the mains lines. The outer contacts can also be in the form of contact pins or sliding contacts in a manner similar to the embodiments of lamps already explained above.

This results in corresponding variants of the rotatability relative to an adapter 69 and/or a lamp carrier 28.

A reflector element according to various embodiments for an electric lamp is constructed in such a way that it is designed at least for photocatalysis and/or for color conversion of incident light, e.g. light emitted by the electric lamp.

In various embodiments, a reflector element can thus be provided which has multifunctionality, as a result of which the mode of operation of an electric lamp and e.g. the illumination properties can be substantially improved. In addition to improved luminous efficacy and the possibility of more targeted illumination adjustments, a concept involving a flat design can thus also be maintained.

In various embodiments, the reflector element can be constructed in such a way that it is designed for light scattering and light reflection and for photocatalysis and for color conversion of the light. By virtue of a specifically constructed and/or coated element, multifunctionality can be achieved. In addition to minimization of component parts, particularly flexible matching of the element to the respective lamp or luminaire is thus also possible, with the result that a very situation-dependent conceptualization is achieved with respect to the use of the lamp or luminaire.

In the context of various embodiments, a reflector element is understood to mean a component part which at least partially reflects light, with this being understood to mean both directional reflection in accordance with the laws of optics with an angle of incidence which is equal to the angle of reflection of the light and scattering.

In various embodiments, the reflector includes a plate-like carrier, which is formed from a transparent material, e.g. from polymer or glass, and is coated with an at least partially reflective layer. The layer can be formed on that side of the carrier which faces the light source during operation and/or on that side of the carrier which is remote from the light source.

In various embodiments, the carrier is formed from at least two different polymers having different refractive indices. Thus, a particularly suitable configuration for light generation can be enabled which is furthermore also designed to be very minimized in terms of weight. Various embodiments provide for a first polymer to be PC (polycarbonate) and for a second polymer to be PMMA.

By virtue of such a configuration of a reflector from two different polymers, it is possible for the intrinsic scattering effect to be intensified. In various embodiments, the carrier is formed from a material which is at least partially transmissive to light, with the result that the design of the light-directing element as a partially mirror-coated reflector with a reflection factor R is provided.

In various embodiments, with a view to the photocatalysis, the reflector element is e.g. coated with TiO₂. By virtue of such a configuration, more efficient air purification is made possible during convection. TiO₂ can also be introduced as material in the at least partially reflective layer. Such a coating may be applied to regions, e.g. to peripheral regions, of the reflector element.

In various embodiments, the reflector element is designed for color conversion of light with a first color temperature to light with a second color temperature which is lower than the first, and the partially reflective layer is a wavelength-selective coating, with the result that the reflector element is formed as a dielectric mirror or as an interference filter. No color conversion layer is formed in this case.

Alternatively, various embodiments may also provide for the reflector element to be designed for color conversion of light with a first color temperature to light with a second color temperature which is lower than the first, and for the partially reflective layer to be a color conversion layer.

Owing to the design according to various embodiments, reflected light can have a different color than transmitted light, which opens up new design possibilities and e.g. enables improved matching of the light to illumination scenarios. Thus, for example, light of a lower color temperature, which is often perceived by humans to be more pleasant, can be emitted preferably in one direction, while light with a higher color temperature, which is often perceived to be cold, is emitted to an increased extent in another direction. It is thus possible, for example, for a sufficient supply with circadian-effective light, on the one hand, and illumination which is perceived to be pleasant of specific areas, on the other hand, to be provided. One possibility for achieving this would be to illuminate walls or ceilings with light of a high color temperature, i.e. daylight-like spectrum, for example while illuminating a living area with light of a lower color temperature by corresponding fitting and design of the reflector element.

In various embodiments, for light scattering, scattering bodies are formed in the reflector which are formed at least partially as scattering bodies consisting of a phosphor material, in particular of the type YAG:Ce. Furthermore, for example, corresponding phosphors are possible in which the element yttrium is replaced partially or completely by one of the rare earth metals.

Provision may be made for the at least partially reflective layer to be applied to that side of the reflector which faces the lamp during operation. As a result, direct reflection can be achieved. However, provision may also be made for this coating to be applied to that side of the reflector which is remote from the lamp. In such a configuration, reflection is only made possible after transmission of the carrier of the reflector layer. The polymer material of the carrier has e.g. a corresponding transmittance T.

Depending on the configuration and the individual versatility, the reflector can thus be matched in a situation-specific manner, and light is either virtually completely reflected or virtually completely transmitted, depending on the size of the reflection factor R and of the transmittance T of components or material constituents of the reflector. It is thus possible in this respect to also achieve degeneration of the reflector with respect to the cover disk.

The reflector or the cover disk may also be designed in such a way that they can be used as convection limiters and virtually eliminate convection. As a result, corresponding heat-sensitive lamps which are constructed on the basis of low-pressure discharge lamps, for example, can also be used in very cold environments, such as in cold stores, for example.

Precisely as a result of the admixture of TiO₂, it is possible, in conjunction with UVA radiation, to enable a photocatalytic decomposition reaction of organic vapors which result in the formation of CO₂, water and nitrates. This enables air purification, precisely in conjunction with the use of low-pressure discharge lamps with an integrated operating device.

Furthermore, the photocatalytic reaction is made possible without the generation of negative ions. If the reflector is arranged on the upper side of the lamp and the TiO₂ layer is applied to the inner side of the reflector, furthermore, the air always comes into contact with the TiO₂-coated reflector owing to convection, which results in a high air throughput and therefore in efficient air purification.

In various embodiments, the material to which the reflective layer is applied is designed to be light-scattering and has a scattering capacity S. If the reflectance is equal to 0 and the transmittance is virtually 100% and the scattering capacity is equal to 1, the reflector degenerates with respect to the scattering disk. The scattering capacity can be used for adjusting the glare, and this glare can be reduced correspondingly.

In various embodiments, the scattering bodies consist at least partially of a phosphor, in which case in this regard e.g. a phosphor is provided which converts blue light, for example mercury lines and parts of the BAM spectrum into longer-wave light, for example in the green-red spectral range with a temperature shift with respect to that of the light source. Mention is made here by way of example of the previously mentioned phosphor of the type YAG:Ce.

In various embodiments, the grain structure d of the phosphor is in the range between 1 μm and 50 μm.

In various embodiments, provision is made for the phosphor to be formed as an additional layer on the at least partially reflective layer. In various embodiments, the phosphor may be contained in the granules of the polymer from which the plate-like carrier is formed.

The transmittance of the reflector may be adjusted e.g. via the thickness of the reflector layer. An aluminum-containing material, for example, may be provided as the material of the reflector layer. If the reflectance is intended to be R=100%, it is also not possible for transparent polymers to be used as the materials of the carrier, for example ABS, PBT and PET.

In various embodiments, nanoparticles in the form of TiO₂ anatase are formed.

It is also possible for silver ions to be provided for enhancing the antibacterial effect.

In reflector applications, a grain size of between 0.2 and 1 μm, e.g. 0.5 μm, may be provided.

In applications with a scattering disk, layer thicknesses of between 0.1 and 0.6 μm, e.g. 0.2 μm, are provided.

Precisely when the lamp with which the reflector is operated has a helical discharge vessel, this helix tends to be wound broadly and has an average pitch. As a result, the LOR and the efficiency of the lamp may be maximized.

If the helical configuration of the discharge vessel is coated with an inhomogeneous layer thickness of the phosphor, the side with a thicker phosphor layer may be aligned in the direction in which less light is intended to be emitted by the lamp or on the side on which the reflector is intended to be fitted.

In various embodiments, the discharge vessel may have a thicker phosphor layer on the side facing the reflector than on the correspondingly remote side. As a result, an asymmetrical production of layer thickness which occurs when the phosphor is applied to the discharge vessel may be utilized in a targeted and defined manner

In various embodiments, in terms of its functionality, the reflector may be designed for color conversion of light with a first color temperature to light with a second color temperature, which is lower than the first.

In various embodiments, a lamp with such a reflector may beconfigured in such a way that the light emitted by the light source can be divided proportionately into a reflected proportion and a transmitted proportion by means of the reflector, and the ratio of proportions is freely adjustable.

A lamp according to various embodiments or a lamp module with at least one reflector element may include at least one light source and an electronic operating device. Electronic component parts of the electronic operating device may be arranged laterally with respect to the light source in a first housing part, which is formed circumferentially around the light source. By virtue of such a configuration, the flat construction may be once again reduced since the component parts are arranged virtually not behind the light source but laterally with respect thereto and in particular furthermore also in the circumferential direction around the light source. Not least, such a configuration also makes it possible to achieve greater versatility and more multilateral light emission. Thermal problems during operation of the lamp can likewise be reduced, in the same way as it is possible to increase the luminous efficacy.

In various embodiments, the electronic operating device and the light source may be arranged in a common housing; by virtue of such a configuration, the number of component parts can be reduced and the mechanical stability of the lamp may be improved. It is not necessary for a plurality of separate housings to be formed which makes it possible to make savings on material and production costs as well.

In various embodiments, the light source and the electronic component parts of the operating device are arranged in one plane. This may be a particularly advantageous configuration in view of the reduction in physical height and the flat configuration.

In various embodiments, the electronic component parts may be arranged in the first housing part in the circumferential direction of the light source around said light source. By virtue of such a configuration, more variable and more uniform distribution of the component parts may be achieved. Furthermore, it is possible to ensure greater adjustment of the distance between the component parts, with the result that thermal influences can also be reduced in this respect.

In various embodiments, a dividing wall may be arranged in the housing between the electronic component parts and the light source. By virtue of this configuration, it is possible firstly to once again markedly reduce the thermal influence of the component parts during operation of the lamp owing to the emission of heat by the light source. Furthermore, any undesired emergence of light in the direction to the side of the component parts of the operating device can be avoided. Precisely when this dividing wall is formed at least partially as a reflector on that side of the dividing wall which faces the light source, the targeted light reflection and targeted emission of light in the desired directions can be improved.

Provision may be made for the lamp to have electrical contacts on its outer circumferential side, said electrical contacts being provided for making contact between the lamp and electrical contacts of a mains supply or a DC voltage supply. Provision may be made for the lamp to have a base, on which the contact pins may be arranged in such a way that they extend laterally outwards and can be connected to contacts of a fitting for a luminaire. The base can be arranged directly on the housing, e.g. integrated therein.

In various embodiments, provision may therefore be made for the first housing part in which the electronic component parts are formed and which may surround the light source in the form of a ring to at the same time also have the base. The first housing part therefore may virtually surround a second housing part, in which the light source is arranged.

In various embodiments, the lamp is circular when viewed from the front, with the result that it in particular represents a flat disk. The first housing part may therefore be a ring.

In various embodiments, the height of the lamp is greater than 20 mm, e.g. in the range from about 10 mm to about 20 mm.

Provision may be made for the first housing part in which electronic component parts of the operating device are arranged to be higher than the second housing part, in which the light source is arranged. In various embodiments, provision may be made in this regard for the first housing part to be at most 60% higher, e.g. 55% higher, than the second housing part in this case. In various embodiments, provision may be made for the height of the first housing part to be 18 mm and for the height of the second housing part to be 12 mm. Thee are merely exemplary configurations of a lamp in which the first housing part is higher than the second housing part. In various embodiments, in a configuration in this regard, provision is made for the electrical contacts to be formed on the side wall of the first housing part. Provision may also be made for the first housing part and the second housing part to be designed to have the same height. In this regard, a symmetrical hollow-cylindrical configuration with the same height over the entire radius may then virtually be provided.

Furthermore, provision may be made, in a further embodiment, for the first housing part to be lower than the second housing part. Precisely when the lamp is a discharge lamp, and the discharge vessel of the light source does not extend in one plane but over a certain height, which is substantially smaller than the width and the depth, a slightly higher second housing part may be required. A discharge vessel which has a conically wound discharge tube may be mentioned by way of example here.

In various embodiments, a ratio between the height of the first housing part with the electronic component parts and a second housing part, in which the at least one light source is arranged, may be in the range from 0.8 to 2, e.g. in the range from 1.0 to 1.5.

In various embodiments, a ratio of an outer diameter of the first housing part to an outer diameter of the second housing part, in which the at least one light source is arranged, may be in the range from about 1.2 to about 2, e.g. in the range from about 1.4 to about 1.7, e.g. 1.5. By virtue of such dimensions, as much radial space as possible remains for the light source, with the result that the luminous efficacy and the light emission and therefore the LOR (light output ratio) may markedly be improved. Furthermore, by virtue of these dimensions, a surrounding ring in accordance with the first housing part can be provided which can accommodate a sufficient number of electronic component parts of the housing part, likewise owing to its circumferential length, and can also be formed so as to be relatively thin radially in this respect.

Relatively small values for the ratio of the outer diameter of the first and second housing part can be realized if the number of components which need to be accommodated in the first housing part can be reduced. This can be realized, for example, by virtue of the fact that parts of the electronics which are required, for example, for implementing the harmonic standards and for rectification, for example, are transferred to a third housing part, which supplies a 60V DC voltage to the electrical contacts of the lamp, for example.

In various embodiments, provision can also be made for the electronic operating device to have a first operating device part, whose electronic component parts are arranged in a first housing, which represents the first housing part. The operating device furthermore includes a second operating device part, whose electronic component parts are arranged in a further housing, which, pursuant to the above numbering, is the third housing. The third housing is arranged so as to be spaced apart from the lamp and also so as to be spaced apart from the first operating device part. By virtue of the electronic operating device being divided into two separate units in this way, said units being spaced apart from one another as well, it is possible to achieve very specific component part division.

By virtue of this configuration, the compatibility of a luminaire with a lamp in view of the use and versatility of different lamps can be improved, with more flexible use of the luminaire also thus being enabled.

In various embodiments, provision is made for the two operating device parts to be connected electrically by at least one low-voltage line. In various embodiments, provision can be made in this case for this low-voltage line to therefore also be formed without any enveloping insulation and thus nevertheless to meet the corresponding safety requirements. It is thus also possible to come into touching contact with this low-voltage line without a person touching the line being injured.

In various embodiments, the output voltage at the second operating device part and therefore also the voltage transmitted via the low-voltage line is less than or equal to 60V. In view of the safety requirements in respect of a person coming into touching contact with the line.

In various embodiments, the second operating device part has electronic component parts for connecting and isolating the luminaire with the lamp from a power supply system and furthermore also may include component parts for performing power factor correction.

In various embodiments, a suspension device for suspending the luminaire from a ceiling of a room is formed on the third housing. In addition to the electronic functionality, the third housing therefore also has a further additional functionality for fixing the luminaire. Provision may also be made for further functional components, such as a fan, an aroma dispenser, a source of noise, which is e.g. coupled to a doorbell, a signal receiver, a smoke detector, a weather station or the like, to be arranged in or on the third housing. In the case of a signal receiver, provision may be made for said signal receiver to receive control signals by remote control, it being possible for said control signals to be used either for light scattering (brightness, color) and/or for programming and operating the additional electronic or non-electronic components.

In various embodiments, the first operating device part is arranged on the lamp, e.g. integrated in the lamp. In various embodiments, therefore, an inseparable connection, which therefore cannot be detached without causing destruction, is formed between the second operating device part and the lamp. As a result, a compact configuration with minimized installation space may be made possible. Precisely in this regard, therefore, the division of an electronic operating device into two operating device parts provides the possibility of matching the second operating device part to the lamp directly connected thereto in a functionally individual manner. The second operating device part can therefore be virtually superordinate in terms of its functionality and can be configured for compatible operation with a large number of different lamp types, wherein in this regard the compatibility in terms of the signal transmission to the first operating device part is also ensured. The multiple compatibility of a wide variety of configurations is ensured by virtue of this, which increases the versatility and different possible configurations of the luminaire with the lamp yet again.

In various embodiments, the first operating device part has electronic component parts for decoding control signals received from the second operating device part. The control signals may e.g. have signals for dimming and/or changing the color of the light emitted by the lamp. In various embodiments, the first operating device part may therefore be a dimmable ballast.

Provision may also be made for a lamp to have a plurality of light sources, each having an operating voltage of 12V, which are connected in series. A low-voltage principle is thus realized, in which a plurality of lamps or light sources of a lamp are arranged in a series circuit, with the number of lamps or light sources being selected in such a way that a DC voltage of 60V is not exceeded.

In various embodiments, the outer diameter of the first housing part may be in the range from about 80 mm to about 220 mm, e.g. in the range from about 100 mm to about 200 mm, and e.g. 120 mm.

In various embodiments, the light source and e.g. the second housing part extend over a width of at most 200 mm, e.g. greater than 150 mm and e.g. in the range from about 60 mm to about 100 mm, with 80 mm being a preferred value worth emphasizing.

By virtue of the arrangement of the electronic component parts in the circumferential direction around the light source, a design with substantially less thermal loading by virtue of the lamp being thermally decoupled as far as possible from the electronic operating device can be achieved. No interface between the lamp and the operating device is required and very high luminous fluxes and high efficiency may be achieved. Furthermore, bidirectional emission with a particularly high LOR may be achieved. In addition, rotationally symmetrical emission can be achieved. Precisely in the case of configurations of the lamp with a base/fitting system, this may furthermore also be formed without any coding keys.

Provision may be made for the lamp to have at least two, e.g. three, e.g. four electrical contacts. These may be in the form of flat pads or else contact pins. Provision may be made for two electrical contacts, e.g. contact pins, to be designed for connection to a mains supply or a DC voltage supply, for a third contact to be designed for connection to ground potential and for a fourth contact to be in the form of a control line, via which the lamp receives information relating to the adjustment of the brightness and/or the coloration of the light generated by the lamp.

Provision may be made in this regard for the contacts to be arranged directly on the housing if the lamp is formed without a base.

If the lamp includes a base, the electrical contacts may be formed on this base. If the lamp has a base and can be inserted into a luminaire with a fitting, provision may be made for all of the elements of the base to be arranged in a segment of a circle with a diameter which is between 2 mm and 40 mm greater than the outer diameter of the base or the first housing part on which the base is arranged.

In various embodiments, in respect of the configuration of the luminaire with at least one lamp, a flat, plate-like conceptualization may be provided. The lamp carrier may consist of a single plate, which has cutouts, into which the lamp can be inserted correspondingly. For example, it is possible in this case for a possible use similar to a bayonet-type closure to be provided. In this regard, provision may be made for the lamp to also have at least one locking element, in addition to the electrical contacts. This locking element may be arranged so as to be spaced apart from the electrical contacts on the circumferential side. First, the lamp may be inserted into the plate-shaped luminaire, which has the lamp carrier in the form of the plate, and the position may then be adjusted by rotation in the inserted position about the longitudinal axis of the lamp. In said position, there is then contact between electrical lines which are laid into this plate-like lamp carrier by virtue of the electrical contacts.

In various embodiments, recesses may be formed in this plate-like lamp carrier at the periphery with respect to the cutout, with the contacts being guided in said recesses during the rotary movement to reach the end position of the lamp in the lamp carrier. In this regard, the recess is in the form of a cavity in the plate.

Provision may also be made for the lamp carrier to be formed from two separate plates, which are connected to one another. The locking element and the electrical contacts may in this case be arranged in different planes in respect of the configuration of the lamp in terms of height, and provision may be made for a recess to be formed in a cutout for the locking element in the first plate and for a recess to be formed in a cutout for the electrical contacts in the second plate. Given such a configuration, the locking element and the contacts may then be arranged and guided in the lamp carrier virtually at different height levels. The fixing of the lamp in the lamp carrier and the electrical contact may thus be ensured in a reliable and permanent manner

Provision may also be made for the at least two electrical contacts to be arranged on opposite sides of the lamp and to lie virtually on a straight line through the center point of the lamp.

Furthermore, provision may also be made for two contacts to be arranged on one side and to be positioned directly one above the other, when viewed in the vertical direction.

An electrical contact may also be in the form of a twin contact, with an inner pin part being designed for making contact with the mains voltage, for example. Electrical insulation is then provided on the outside around this first pin, and a second contact, which is designed for controlling the coloration or for making contact with ground potential, for example, is arranged on the outside around said insulation. In the case of a single contact pin, therefore, two separate contacts are provided, which can be electrically insulated from one another by a hollow cylindrical insulating sleeve.

In various embodiments, provision may be made for a module diameter to be 120 mm, for example. Furthermore, a diameter of a luminaire opening may be 121 mm, with the distance between two mains lines in the lamp carrier preferably being 123.5 mm. Furthermore, a diameter of a movement zone in the lamp carrier in which the contact pins and/or a locking element of the lamp then also extend and protrude beyond the outer side of the module diameter, is e.g. 126 mm. A distance in terms of diameter between two mutually opposite contact carriers may be 130 mm, with a spring excursion of these spring contacts preferably being 1.2 mm in this regard.

Provision may be made for the luminaire to be designed to accommodate a plurality of lamps. The lamps can all be of the same lamp type and be flat lamps, for example, which are in the form of discharge lamps. They may have different or identical diameters.

In various embodiments, provision may be made for the luminaire to be designed to accommodate at least two different lamp types. For example, provision may be made here for a discharge lamp which has the physical form of a flat lamp to be used as the first lamp type. Furthermore, a further lamp on the basis of light-emitting diode technology may be used. In this regard, organic light-emitting diodes, so-called OLEDs, can also be provided. Furthermore, it is also possible for lamps on the basis of halogen lamps to be used. Such a versatility and such multiple possible uses of different lamp types, i.e. lamps which are constructed using different technologies, increase(s) the application spectrum of the luminaire considerably.

Provision may be made for the luminaire with its plate-like lamp carrier and its correspondingly flat lamps to likewise be in the form of a flat plate in the form of a disk or the like. The different lamps or the plurality of lamps may be used in a wide variety of geometrical distributions in the luminaire or the lamp carrier of the luminaire. They may be arranged in different ring segments around a central point of the lamp carrier of the luminaire. In this regard, they may furthermore be arranged with different angular offsets with respect to one another, when viewed with respect to the circumferential direction. Therefore, a wide variety of possible applications and possible uses result, which means that a large number of illumination options, illumination patterns and the like may be produced.

In respect of the module configuration, the excess diameter between the module diameter and the diameter of the movement zone for the contact pins and the at least one locking element may be in the range from about 2 mm to about 10 mm, e.g. in the range from about 4 mm to about 8 mm, and e.g. 6 mm.

In various embodiments, at least two electrical contacts are arranged with 180° symmetry with respect to the cylindrical lateral surface of the lamp. This results e.g. in the possibility of the lamp rotating about the contact axis, which runs through the central point of the lamp.

Precisely when more than two contacts are provided, further contacts may be realized by contact pairs which are arranged one above the other or via twin contacts which are interleaved with one another.

In the case of two separate contacts arranged one above the other, the distance between them may be in the range from about 2 mm to about 8 mm, e.g. in the range from about 3 mm to about 4 mm.

In various embodiments, the electrical contacts may be in the form of spring contacts.

In various embodiments, the length of these electrical contacts may be in the range from about 2 mm to about 8 mm, e.g. may be in the range from about 4 mm to about 5 mm when viewed in the radial direction.

The contacts may be formed in the outer region and therefore parallel to the lateral surface of the first housing part, in particular areally. The dimensions are may be in the range from about 0.5 mm to about 2.0 mm, e.g. about 1.5 mm. They may be matched to the size of the mating element with which contact is to be made and against which they can bear in particular in a sprung manner

In terms of this contact-making, an electrical line which runs parallel to the luminaire axis and with which contact is made by a contact is preferably formed in the lamp carrier.

In various embodiments, the lamp carrier may have a rotationally symmetrical undercut zone in the region around the electrical contacts. This undercut zone may be dimensioned such that, firstly, the electrical lines are arranged in such a way as to prevent touching contact therewith and, furthermore, the contacts may be resilient in this region.

The lamp may include at least one locking element, which may be arranged e.g. in elastically sprung fashion on the cylindrical circumference of the lamp housing. In various embodiments, the spring direction is in the radial direction of the lamp. In this respect, provision may be made, for example, for slots to be introduced above and below the locking element.

A locking element may have the form of a hemisphere with a possible height of greater than 1 mm, e.g. in the range from about 1 mm to about 5 mm, e.g. about 3 mm.

A locking element may be arranged at an angle with respect to an electrical contact element of between 30° and 60°, e.g. at an angle of 45° with respect thereto.

In various embodiments, the electrical contacts and the at least one locking element are virtually threaded through into the luminaire-side opening via corresponding insertion slots when the lamp is inserted into the lamp carrier.

Once the electrical contacts have been threaded in in this way, the lamp may rest on the lower side of the undercut zone on the locking element, as a result of which mechanical loading of the electrical contacts is avoided.

In various embodiments, the electrical contacts and the at least one locking element are freely rotatable about the longitudinal axis of the lamp in this undercut zone up to the region which has an inwardly directed shaped portion for each locking element, with the locking element latching into said shaped portion once a certain force has been exceeded.

In various embodiments, the angular distance between the electrical contacts and a locking element is a position which is matched with respect to one another in such a way that, after the locking, the contacts are perpendicular to the e.g. linearly guided electrical lines.

In various embodiments, the end position of the lamp in the lamp carrier is reached after the insertion in the direction of the lamp longitudinal axis and a subsequent rotation through 45°.

In various embodiments, provision may be made for the lamp carrier, e.g. the plate-like lamp carrier, to be designed to be open at the top and/or bottom at the end positions of the locking element in the lamp carrier. It is thus possible, given a predetermined capacity of the lamp to rotate or tilt relative to the lamp carrier, for the locking element to snap out of the lamp carrier.

Fitting elements may be incorporated in the plate-like lamp carrier.

In various embodiments, the luminaire has an insert in the form of an injection-molded part in the region of the fitting, said insert having all of the mechanical fitting elements, e.g. apart from the power supply lines.

In various embodiments, the lamp may be pivoted or rotated about at least one axis of rotation, with this axis of rotation running through at least two contacts and the central point of the lamp. Precisely in the case of reflector applications, this may be advantageous since different positions of the lamp can be produced and thus different illumination positions and different types of illumination can be achieved. This rotatability may be advantageous when the lamp module is in the form of an LED module, since in this case the intensity of the LED contributes to the emission of directional light.

Furthermore, in the case of a round lamp or a disk-shaped lamp, it is possible to make contact with lamps from adjacent regions using the same conductor in the luminaire.

Given the capacity of the lamp to rotate and the corresponding configuration of the contacts, provision may also be made for contact to be made between the lamp-side pin and the luminaire-side wire purely by means of bending torques, which result given the corresponding configuration of the dimensions (pin diameter and distance between the luminaire-side wires, and the materials). In this regard, a distribution of the contact pin between the two lines or wires in the luminaire is virtually made possible.

Provision may be made for outer pins to be provided for connection to the mains lines and to provide protection against electric shock, with the possibility of an inner pin for making contact with ground potential and a control line, in which no protection against electric shock needs to be provided, however. This configuration with twin contacts may be advantageous in view of multifunctional uses, given the capacity of the lamp to rotate and for space-saving configurations.

In various embodiments, the lamp may be in the form of a flat cylinder, which means that its height is smaller, e.g. much smaller, than the width and depth.

In terms of the production of such a luminaire with at least one flat lamp, provision may be made for a plate-like lamp carrier to be formed, in which a flat lamp can be inserted. The luminaire may thus be produced with a minimum number of component parts, wherein, in addition to a lamp, the lamp carrier may be produced merely from a plate or two assembled plates as essential component parts.

In respect of known configurations, such a configuration with a simple flat design therefore also makes it possible to achieve a situation in which there is no restriction to the choice of lamp on the basis of the base/fitting system provided in the luminaire. Furthermore, it is also possible, in addition, for a control line for selectively driving lamps or groups of lamps, for example with the aid of a light management system, to be enabled, which is not the case in conventional systems. Furthermore, when using halogen light sources as the lamp in the luminaire, it is no longer necessary to interpose a very cost-intensive luminaire hood, such as in the case of track-mounted systems, for example. Furthermore, simply accommodating an electronic operating device with minimized installation space in linear luminaires can be substantially improved in comparison with the prior art. By virtue of such a configuration of a luminaire and production thereof, it is possible to provide a use of lamps with overlapping technology, including both halogen lamps with an integrated operating device, low-pressure discharge lamps with or without an integrated operating device, light-emitting diode modules and OLEDs with integrated driver modules.

Furthermore, it is also possible for a plurality of such plate-like individual luminaires to be capable of being connected to one another in a simple manner, with the result that variously configurable luminaire systems comprising a plurality of luminaires can be produced. For example, luminaires can be connected by simply being plugged together or by contact being made between the respectively integrated electrical lines. A flexible solution to illumination problems can thus be provided in a simple manner which is more precise and comprehensive. Precisely when using low-pressure discharge lamps, a high efficiency of greater than 90 mW can be achieved. In the case of a bidirectional emission, furthermore, the light output ratio can be substantially improved. Not least, high powers and luminous fluxes of up to 30 klm/m can also be achieved, with the result that, in this regard, justice will also have been done to a suitability as so-called high-bay luminaire. Furthermore, it can also enable the use of reflectors and air purification concepts.

The lamp carrier may be constructed substantially from one or two planar plates. These plates may have any desired geometries. In various embodiments, rectangular or circular or oval plate-like configurations may be provided. In various embodiments, the plates are formed from an electrically nonconductive material, such as polymer, wood or glass, for example, or from a PMMA material, which is also referred to as Plexiglas. In various embodiments, such a plate is in the form of a profiled plate, which may have reinforcing struts in corresponding regions. Recesses in the form of continuous holes with a e.g. standardized diameter for accommodating different lamp modules are formed in these plates. A lamp module may be designed so as to correspond to a lamp, as is explained in detail and variously at the outset. The cutouts in the plates have notches and milled portions in the form of peripheral recesses, which form a base/fitting system together with the corresponding complementary elements of the lamp.

It is also possible for inserts consisting of plastic to be used instead of these notches and milled portions in the plates, said inserts containing all of the mechanical fitting elements as injection-molded parts.

Electrical lines, which are connected to the mains voltage, a DC source and the protective earth and the control line, are laid in the light-emitting module or in a luminaire, e.g. spaced apart with respect to the center points of the cutouts for the lamps. In various embodiments, these lines are arranged behind a milled portion and are therefore arranged in such a way as to ensure that touching contact cannot be made with them and therefore in a manner with protection against electric shock.

The lamp modules or lamps may be connected to the electrical lines e.g. via spring contacts or twin contacts, for example. Provision may be made for an electrical line which is laid in the lamp carrier to have a rectangular cross section, as a result of which the contact by virtue of an electrical contact element of the lamp is improved and is made more secure. In various embodiments, a contact element then bears flat against this specific line cross section.

Provision may be made for a lamp to have further elements which may also be in the form of a cover disk, a grid or a reflector and are part of the lamp. In various embodiments, such an element also has a light-directing function and is preferably fastened on the first housing part.

Precisely when a lamp carrier of the luminaire has, in rectangular form or in any form, a linear peripheral limit, a particularly suitable connection to a further luminaire module, for example by virtue of simply being plugged together, is possible at this point. This makes it possible in a simple manner to construct a light-emitting module system. Even corner joints, for example a 90° bend, can thus also be realized.

If the lamp is in the form of a discharge lamp, it may include a light source which has a wound discharge vessel which is filled with a gas. The discharge vessel is preferably wound a plurality of times. In various embodiments, the discharge vessel may be arranged detachably, for example by means of clips or clamps. In various embodiments, the discharge vessel is helical and has a helical dome in the center. This may e.g. be thermally conductive and is arranged, for example, on an element, such as a reflector or a metallic grid, which may also at the same time be in the form of an element for reducing glare. In various embodiments, the element is mechanically connected to the first housing part, e.g. is arranged on an inner side of the housing of the lamp between the discharge vessel and this inner side of the housing. In various embodiments, this linking interface is standardized, with the result that compatible use of different elements is possible. By virtue of such a thermally conductive contact between this helical dome and this element, which is also preferably connected to ground potential so as to reduce electrosmog, it is possible to achieve the formation of a so-called cold spot.

In various embodiments, provision may be made for the lamp to have two reflector elements. In this case, a first reflector element may be arranged on a side facing the upper side of the lamp and a second reflector element is arranged on a side facing the lower side of the lamp. In various embodiments, the reflector elements are arranged above and below the housing part, in which the discharge vessel is located.

In a first embodiment, provision is made for the first and second reflector elements to each be a dielectric mirror, which dielectric mirrors are coated e.g. with a respective wavelength-selective coating on the sides facing the discharge vessel. The two reflector elements are formed without a color conversion layer. In various embodiments, the coating applied to the upper reflector element is formed in a wavelength range from about 350 nm to about 480 nm with a reflectance of greater than 70%. In various embodiments, the second coating on the lower reflector element may be formed in a wavelength range from about 750 nm to about 820 nm with a reflectance of greater than 70%.

By way of example, provision may be made in this embodiment for a distance between two turns of the helically wound discharge vessel to be between 0.5 times the outer diameter of the discharge vessel and one times the outer diameter, e.g. 0.75 times the outer diameter.

In a second embodiment, provision may be made for at least regions, e.g. the peripheral regions, of the first reflector element to be coated with TiO₂ on the side facing the discharge vessel, and for at least regions of the second reflector element to be coated with a color conversion layer on the side facing the discharge vessel. At least the second reflector element is formed without a wavelength-selective coating. The first reflector element may have such a wavelength-selective coating, but does not have a color conversion layer. In various embodiments, a titanium oxide coating may be provided in the peripheral regions which only extend over the first housing part of the lamp.

In the second embodiment, provision may be made for a distance between two turns of the helically wound discharge vessel to be in the range from about 0.4 mm to about 3.5 mm.

By way of example, in the second embodiment, a ratio between a distance between two turns and an outer diameter of the discharge vessel may be in the range from about 0.03 to about 0.3, e.g. in the range from about 0.02 to about 0.2.

In various embodiments, such a distance between two turns of the helically wound discharge vessel is between 0.4 mm and 3.5 mm. For example in the case of bidirectional emission, this distance may be less than 1 mm.

The distance between two turns or the pitch s of the helix (=ratio between the distance between adjacent turns and the diameter of the discharge tube) of the helically wound discharge vessel is e.g. adjusted such that it is matched in optimum fashion to the lighting task. If the lamp is designed as a downlight, for example, the pitch should not be too small in order that a reflector can deflect the light emitted towards the rear back towards the front. The pitch s may in this case be 1.3<s<2, e.g. 1.6 . . . 1.8. If the lamp is designed as a bidirectional uplight and downlight, the pitch s may be even smaller since, in this case, the size of the light source plays a more important role. Examplary values are 1.1<s<1.5, e.g. 1.2<s<1.3.

In various embodiments, the distance between turns is dependent on whether the lamp is used as a directional light source or as a bidirectional light source (uplight and downlight).

Furthermore, a ratio between a distance between two turns of the discharge vessel and an outer diameter of the discharge vessel be in the range from about 0.03 to about 0.3, e.g. in the range from about 0.02 to about 0.2.

In various embodiments, the reflector element is designed for color conversion of light from a light source with a first color temperature to light with a second color temperature, which is lower than the first, and/or the partially reflective layer is a wavelength-selective coating, in which the transmitted light has either a higher or a lower color temperature in comparison with the first color temperature of the light source.

In various embodiments, the lamp is designed for bidirectional emission of the light and different dichroic mirrors are used as reflector elements for the two emission directions upwards and downwards, wherein a first mirror predominantly reflects the blue components in the spectrum of the lamp and a second dichroic minor primarily reflects the red components in the spectrum of the lamp.

In various embodiments, provision may be made for the first dichroic mirror above the lamp to primarily reflect the red components in the light spectrum of the lamp and for the second dichroic mirror below the lamp to primarily reflect the blue components in the spectrum of the lamp.

In various embodiments, the first mirror has a (blue) reflection edge in the range between 400 nm and 550 nm, with the reflectivity in this spectral range at most e.g. being from about 60 to about 100% and further e.g. in the range from about 70 to about 80%, in order then to drop to values of less than 10%, and e.g. less than 5%, in the spectral range from about 500 nm to about 550 nm.

In various embodiments, the second mirror has a (red) reflection edge in the range from about 630 nm to about 800 nm, with the reflectivity in this spectral range at most e.g. being in the range from about 60 to about 100% and further e.g. in the range from about 70 to about 80%, in order then to fall to values of less than 10%, and e.g. less than 5%, in the spectral range between 630 nm and 700 nm.

In various embodiments, the discharge vessel extends in one plane.

In various embodiments, provision may be made for the discharge vessel to be coated with an air purification layer, for example to be coated with TiO₂.

In various embodiments, provision may be made for the lamp to have at least one second housing part, in which the at least one light source is arranged, with at least one or more openings being formed in the upper side and/or in the lower side of this second housing part, said openings allowing air to flow through. As a result, targeted dissipation of heat via convection can be realized, which makes it possible to increase the efficiency e.g. of lamps based on LEDs by virtue of the junction temperature of the semiconductor chip which is relevant for the luminous efficacy being minimized. In the case of low-pressure discharge lamps, e.g. lamps based on CFL, the power density can be increased since the additional air flow can be used for adjustable cooling of the cold spot.

Provision may also be made for the first housing part to be formed on the upper side and/or the lower side and/or the side wall so as to allow air to flow through. As a result, it is also possible to ensure the transport of heat out of the region in which the electronic component parts of the operating device are arranged.

In respect of the generation of such an air flow, explicitly a blower or a piezoelectrically driven air fan can be provided, which is arranged in the first housing part. This may be arranged on a circuit carrier, for example.

In various embodiments, the air exchange may be designed so as to be dependent on the operational parameter of the lamp and at least on an element of the lamp which limits the convection in such a way that the cold spot of the lamp in the form of a discharge lamp is e.g. in the range from about 40° C. to about 55° C. given an ambient temperature of between 15° C. and 30° C. In various embodiments, the lamp therefore regulates the air exchange over the area and the temperature gradient between the top and the bottom, which are substantially dependent on the specific power per unit area (W/cm² (lamp area)) and on an ambient temperature.

In various embodiments, the lamp may include an element which limits the convection and which is in particular a diaphragm or a grid or a reflector. In this regard, the cover already mentioned further above may be provided, said cover being formed in particular with openings in the lower side. In various embodiments, the cover has openings in the circumference, as a result of which controlled, adjustable convection is ensured.

Furthermore, the lamp in various embodiments may include a reflector, which can be attached detachably to the housing, e.g. may be attached detachably to the upper side and/or the lower side of the housing. In this regard, provision may be made for it to be attached to the first and/or the second housing part. By virtue of the detachable attachment, a wide variety of lamp variants may be formed simply and quickly.

A considerable advantage associated with this modular construction (in contrast with the prior art in which the lamp is generally completely surrounded by the luminaire) is the fact that all of the elements for optimizing the lighting-engineering properties (reflector, grid, convection regulator, . . . ) are part of the lamp module and it is therefore no longer possible for a negative influence to be exerted by the luminaire.

In respect of the further advantageous configurations of the lamp according to various embodiments, provision may also be made for it to be possible for a contamination prevention element or a dirt trap to be fitted to the upper side of the housing of the lamp. This can be fitted detachably to the first or the second housing part. By virtue of such a configuration, the accumulation of dust or the like which flows via the lamp by virtue of convection on the surface adjacent to the light source, on which surface the light source is fixed (for example the ceiling), can be avoided.

In various embodiments, a further element may be arranged on the lower side of the housing. This may be, as has already been mentioned above, a grid, a reflector or a scattering disk or a Plexiglas plate with a light-directing film applied thereto, such as a BEF (enhancement film). These elements may also be fitted and removed reversibly and therefore increase the flexibility of the lamp module and make it possible for the user to “customize” his luminaire.

The lamp may be configured in different ways in respect of the technology of light generation and therefore in terms of lamp type. It may be in the form of a discharge lamp (low-pressure or high-pressure discharge lamp) and include a corresponding discharge vessel with respect to the light source. In this regard, low-pressure discharge lamps with an integrated or external electronic operating device may be provided.

A further lamp type may be an LED lamp, which has at least one semiconductor component, e.g. a light-emitting diode, as light source. The light-emitting diode can also be in the form of an OLED or organic light-emitting diode, for example.

Precisely when the light source is a light-emitting diode, the carrier of the light-emitting diode may be brought into thermal contact with at least one heat sink, the heat sink being associated in component-specific fashion with the lamp. The heat sink may be in the form of a dome or cylinder and may have a radial rib structure, which may be open on the light entry side and can therefore bring about a chimney effect.

The carrier module on which the light-emitting diodes are arranged may be brought into direct contact with a cooling plate, on which the heat sink is arranged, with the heat sink and the carrier plate being formed on different sides of the cooling plate. In various embodiments, the cooling plate has slots for an air throughput in the outer region. This ensures that air can flow freely through.

Provision may also be made for the heat sink to be formed with an arched structure, and in this regard can be in the form of a paraboloid or the like, for example.

In various embodiments, the housing may be provided with openings for the air throughput in the region of the outer heat sink arrangement. Provision may be made for a fan or a blower to be integrated in the heat sink, said fan or blower ensuring additional air throughput and corresponding further forced cooling.

In various embodiments, the fan is controlled electronically via a temperature sensor measuring the temperature on the printed circuit board. As a result, very targeted air flow generation is made possible by the fan depending on requirements, as a result of which the range of uses of the lamp also includes relatively high ambient temperatures and the efficiency of the lamp is increased.

In various embodiments, the lamp has a cover for trapping dirt particles as a consequence of the convection-driven air exchange on the side facing the top. This may be the contamination prevention element already described above.

Provision may also be made for the lamp to be provided with a reflective coating on the outside, in the case of the use of a reflector, on the side facing the reflector, for example to be formed similar to a metallic mirror.

In respect of the different layer thickness formation of the phosphor on the discharge vessel already mentioned above, provision may be made for the phosphor coating thickness on that side of the discharge vessel which faces the reflector to be varied and, in this regard, to be in the value range from about 2 to about 5 between the ratio of the phosphor coating thickness on the reflector side and that on the opposite light exit side.

Provision may also be made for the discharge vessel to have an additional reflector layer in the interior on the side facing the reflector, said reflector layer e.g. reflecting light in the spectral range which is visible to humans towards the front.

In various embodiments, the light source of the lamp may be arranged in reversibly detachable fashion in the lamp. This is a very specific configuration which is advantageous for light sources relating to halogen lamps, for example. Said lamps may be removed and replaced easily without the electronics used likewise needing to be replaced, said electronics generally having a substantially longer life than that of the halogen lamp.

In various embodiments, the light source is therefore in the form of a halogen light source in such a configuration. Provision may be made for the lamp to have at least two, e.g. a plurality of, halogen light sources, which are advantageously connected in series.

In various embodiments, precisely in the case of the configuration of a lamp with at least one light source as a halogen light source, provision may be made for the lamp to be designed for operation on a voltage of at most 0.5 times the mains voltage and to be connected, in an inner region via a fitting, to a device which connects at least the electrical contacts of the lamp to the contacts in the outer region of the module, said latter contacts being connected to the mains voltage. Precisely in respect of the series circuit including these plurality of halogen light sources, in this regard an advantage is provided since luminaires to date are generally not intended and designed for such a series circuit.

Precisely when using halogen light sources in a lamp, this results in an increase in the efficiency and/or an extension of the life by virtue of a reduction in the operating voltage in the case of a series circuit. Furthermore, a higher energy efficiency class may generally be realized without it being necessary to use a transformer for this purpose. Precisely when connecting halogen light sources to electronic component parts of the operating device which are arranged circumferentially around the halogen light sources, a particularly effective concept may be made possible. Precisely in the case of halogen lamps, the use of halogen light sources in the central region and wiring and indicator electronics in the outer region around these halogen light sources are therefore ensured. The failure of a halogen light source can be indicated by a corresponding indicator lamp, which may be a light-emitting diode, for example. The failure of a lamp may therefore be recognized very quickly and precisely and said lamp may be replaced.

In various embodiments, provision may be made for e.g. from two to five, e.g. four, halogen light sources to be connected in series. As a result, an operating voltage of less than 60V can be achieved given a conventional mains voltage.

Provision may also be made for a lamp to have one or more halogen light sources connected in parallel with a rated operating voltage of 12V and for the electronic operating device, e.g. the ballast, to have a transformer.

Provision may also be made for, for example, five 12V halogen light sources to be connected in series and for the module to be connected to a 60V DC voltage, for example which is made available by a second operating device part associated with the luminaire. In this case, the lamp module does not contain any electronics apart from the indicator elements for the lamp failure.

In various embodiments, the halogen light sources are in the form of pin base light sources.

In various embodiments, provision may be made for these halogen light sources to have an IR (infrared), reflecting coating (IRC).

In various embodiments, the housing in the inner region of the module consists at least partially of a thermally stable material, for example LCP or PPS. In various embodiments, precisely in this region, receptacles are provided, for example for fixing one or more reflectors.

For example when reflectors are provided in such a lamp with halogen light sources, said reflectors may be adjusted in the direction of the lamp axis, as a result of which it is possible to optimize the imaging ratios.

In various embodiments, such an adjustment of a reflector is performed by means of a screw thread at the end of the reflector.

In various embodiments, the lamp fuse is integrated in the electronic operating device, as a result of which lamps with solid holding elements may also be used in the burner without a fuse on the lamp side.

In various embodiments, the lamp fuses are electronic and can be reset, as a result of which it is not necessary for the fuse to be replaced in the event of a lamp failure.

In various embodiments, the housing of the lamp may include a circuit board or a circuit carrier, which contains the fittings for the halogen light sources, which are e.g. in the form of pin base lamps, laterally oriented contact elements, indicator elements for a lamp failure and the associated electronics, an electronic disconnection device or a fuse and a transformer for the operation of 12V halogen light sources on the mains voltage (optional in the case of a parallel circuit). In various embodiments, the indicator elements are in the form of LEDs, which only respond when the mains voltage is applied to a light source.

Furthermore, provision may be made for the power consumption to be balanced in the case of a series circuit comprising a plurality of lamps.

In various embodiments, electrical contact pins are formed on the housing of the lamp, with it being possible for the lamp in a lamp fitting to be rotated about said contact pins. By virtue of such a change in position relative to the lamp fitting, an even more flexible, variable use of the lamp can be made possible. It is possible for specific, local position adjustments and thus quite targeted light emissions and illumination of specific areas to be provided.

In various embodiments, these contact pins are arranged perpendicular to a lamp axis of symmetry. As a result, the free rotation of the lamp about at least one axis can be ensured.

Provision may be made for the lamp to be capable of rotating about at least two axes, which are perpendicular to one another and are located in the plane of the luminaire, the two axes of rotation in each case running through two mutually opposite contact pins. In various embodiments, provision may be made for the lamp to be capable of rotating about at least one further, third axis, which is perpendicular to the other two axes mentioned above. By virtue of such a possibility of multiple rotation of the lamp, the ability to use different types of lamp as reflector lamps is more attractive.

In various embodiments, provision may be made for it to be possible to reduce shading losses using an extension adapter, which shading losses can occur primarily in the case of flat light sources, such as flat lamps in the form of low-pressure discharge lamps, over the luminaire.

Precisely when electrical contacts are in the form of contact pins in the form of twin contacts, embodiments with an integrated operating device with pin base lamps may be made possible. This is possible and may be advantageous e.g. when using rotationally symmetrical multiple contacts and double pins, for example.

Provision may be made for a contact pin to extend with its longitudinal axis axially and in the axis of rotation and therefore to ensure that free rotation about this longitudinal axis is possible.

In respect of the configuration of a contact pin, provision may be made for at least one insulating body to have a larger diameter than the contact with the enlarged diameter and to be used for latching into the fitting system in the electronic ballast. In various embodiments, provision may be made for electrical contacts to be provided as insertion parts in an injection mold for the housing and to be produced by injection molding therein.

In various embodiments, in the case of a twin contact, provision may be made for one of the two outer pins to be brought into contact with the mains voltage, which means that the protection against electric shock with respect to the mating contact on the fitting side can be realized more easily.

Furthermore, a coding system for the contact pins can be provided, with it being possible for coding to be performed, for example, via the pin length and the diameter and/or via journals on or cutouts in the circumference of the lamp housing or the operating device housing.

In various embodiments, provision may be made for the light source of the lamp to be capable of rotating relative to the operating device. Precisely when the specific configuration of the lamp is such that the operating device extends circumferentially around the light source, this option of the ability of the components to move relative to one another also provides a further degree of freedom and a further improvement of the lamp in view of optimum fulfillment of the lighting task.

In various embodiments, the light source is capable of rotating about at least one axis of rotation, which runs through two contact pins.

In various embodiments, provision may be made for the light source and/or the operating device to be capable of rotating relative to a luminaire, in which the lamp is accommodated. As a result, it is possible for yet additional rotation in terms of degree of freedom to be ensured and therefore virtually three components, namely the light source, the operating device and the luminaire, are capable of moving relative to one another.

In various embodiments, the operating device is capable of rotating about an axis of rotation, which runs through electrical contacts of the operating device for making contact with the luminaire contacts.

In various embodiments, provision is also made for the light source and the operating device to be arranged in an adapter, which is capable of rotating relative to the luminaire in which the lamp is accommodated. By virtue of such an additional adapter, it is possible, for example, to increase the distance between the luminaire and the axis of rotation, which makes it possible to avoid shading effects during rotation. This may be advantageous precisely in the case of flat discharge lamps.

In various embodiments, the light source and the operating device of the lamp are capable of moving relative to one another and relative to a lamp carrier and/or an adapter of a luminaire in which the lamp is accommodated in such a way that the light source is capable of rotating about three axes, which are arranged perpendicular to one another, relative to said components.

In various embodiments, the abovementioned adapter is formed with a diameter which corresponds to between 0.8 and 1.2 of the lamp diameter, e.g. to approximately the lamp diameter.

In various embodiments, the electrical lines for electrically connecting the contact pins of the lamp and the luminaire are designed so as to be integrated in this adapter and protected against electric shock.

In various embodiments, electrical sliding contacts are formed on a housing of the operating device. By virtue of this specific configuration of the lamp with very specific contacts at very specific locations it is possible to ensure safe and reliable electrical contact is made with at the same time multiple movability of the lamp with respect to the other components of a luminaire or of components of the lamp relative to one another in a very specific manner. This configuration means that it is possible for the lamp or components of the lamp to be positioned very individually relative to one another, as a result of which very specific illumination possibilities can be set.

In various embodiments, sliding contacts are formed on an outer side of a side wall of the housing. It is thus possible, precisely for the entire lamp, for a quite specific rotation capacity, relative to external components such as a lamp carrier of a luminaire into which the luminaire has been inserted, for example, to be enabled with nevertheless at the same time electrical contact being ensured.

Provision may also be made for sliding contacts to be formed on an inner outer side of a side wall of the housing. Precisely when the lamp is formed relatively specifically in respect of its component arrangement and, when viewed in the horizontal direction, components with which electrical contact is to be made are arranged next to one another, a very specific movement capacity can be ensured between two specific components of the lamp whilst at the same time maintaining the electrical contact.

Provision may also be made for corresponding contacts to be formed both on the outer and on the inner outer sides of a side wall of the housing, as a result of which the multiple movement capacity can once again be increased and therefore the possibilities of lighting scenarios and relative positions of the components with respect to one another can be substantially increased again.

The flexibility in use and versatility of the lamp can thus be substantially increased. Provision may be made for two sliding contacts to be arranged one above the other, when viewed in the vertical direction.

Provision may also be made for two sliding contacts to be arranged on opposite sides of the housing on a straight line through the center point of the lamp. The alternative or else supplementary possibilities therefore demonstrate a wide variety of possible configurations, with the result that a large number of configurations are thus possible, firstly in respect of the positioning of the sliding contacts, which also results in the provision of a wide variety of possible combinations in respect of the individual shape and configuration of the lamp. In all cases, however, reliable electrical contact and at the same time the potential ability of components to move in relation to one another is ensured.

In various embodiments, the operating device is arranged in a first housing part and the light source is arranged in a second housing part, and electrical contact is made between the housing parts by sliding contacts, with the possibility of relative movement of the housing parts with respect to one another being provided via the sliding contacts about an axis of rotation perpendicular to the housing parts. A specific configuration is thus provided in which components of the lamp itself can be rotated relative to one another and nevertheless the reliable electrical contact can be maintained. Precisely when the lamp is in the form of a flat lamp and the operating device surrounds the light source circumferentially, a configuration may thus be provided in which the light source can be rotated about the perpendicular longitudinal axis relative to the operating device, with this first housing part with the operating device surrounding the light source in the form of a ring and circumferentially.

Provision may also be made for electrical contact to be made between the second housing part with the light source and the first housing part with the operating device by means of electrical contact pins and for the housing parts to be capable of rotating relative to one another about an axis of rotation through the contact pins. In the case of such a configuration, no contact is therefore made between the sliding contacts which, in the context of the application, are different from contact pins. As a result of these different types of electrical contacts, different rotary movements of the components of the lamp relative to one another about different axes are thus also provided. Precisely in the case of a configuration with sliding contacts, an ability of the light source to rotate relative to the operating device about an axis through the contact pins and the center point of the lamp, which represents an axis of rotation perpendicular to the longitudinal axis of the lamp, cannot be provided. By virtue of the configuration with contact pins, on the other hand, the rotation about this axis of rotation is ensured, however.

Precisely when inserting the lamp into an adapter, electrical contact may be provided between the lamp and the adapter via sliding contacts, with the result that the ability of the lamp to rotate relative to the adapter about a specific axis and in a specific direction is provided. Precisely by virtue of this, shading losses can be avoided and specific lighting scenarios can be set.

Provision may also be made for these electrical lines to be integrated in the operating device of the lamp.

In various embodiments, extension arms of the adapter in the form of struts are formed and arranged in such a way that they do not impede or impair the rotary movement about a specific axis of rotation.

In various embodiments, in respect of the number of struts, at least two, e.g. two to four are provided.

In various embodiments, provision may be made for the electrical contact system between the lamp carrier and the operating device of the lamp to be coded, with it being possible for coding to be produced, for example, via the length and/or the diameter of the contact pins.

In a possibly advantageous manner, provision may be made for the rotary movement of the lamp to take place via a motor-operated drive, which can be controlled by a user, furthermore e.g. via remote control, for example.

Provision may also be made for the luminaire to have an electronic control unit with a memory, in which lighting scenarios can be stored. This control unit can be programmed and set, for example, via a control panel or via remote control.

Provision may be made for it to be possible for different reflector lamps to be used for different lighting scenarios. Thus, for example, as a first application, images can be radiated on to a wall with one or more lamps of a light-emitting module or a luminaire. As a second functional application, provision may be made for the implementation of a reading lamp, in which case numerous further specific applications can be provided as well, which applications can be set and stored as lighting scenarios. Precisely when a light-emitting module is equipped with a plurality of possibly also different lamps and lamp types, the generation of very different and very versatile lighting scenarios can be performed very precisely and in tune with requirements.

In various embodiments, the axes of rotation and moments of inertia of the objects about the axes of rotation are matched to one another in such a way that torques about the axis of rotation are so low that the frictional forces between the electrical contact pins and the receptacle therefor continue to keep the lamp precisely in its position.

In the case of a configuration of the lamp as a low-pressure discharge lamp with an external operating device and two contact pins, which are in the form of twin contacts, for example, preheating is possible.

The abovementioned adapter may also enable matching of the lamp diameter, wherein, for example, the lamp may have the same diameter, a larger diameter or a smaller diameter than a corresponding lamp without such an adapter. A practical upper limit for a corresponding diameter is provided by the pitch of the openings in the luminaire.

Furthermore, the construction with an adapter enables, in addition to rotation about already existing axes, rotation about a further axis oriented perpendicular thereto. This is in various embodiments possible when the mains lines and control lines are arranged in the form of a circle around the lamp.

When using an adapter, the connection between the adapter and the lamp carrier or the lamp may also be realized on the basis of four separate contact pins since, in this case, a multiple pin principle at the junction between the adapter and the lamp carrier or the lamp is not required. This is because all of the axes of rotation are then in the adapter region.

Provision may be made for the electrical lines to be produced by means of vapor deposition or MID technology or simply by laying of lines and contacts.

Further features of various embodiments are given in the claims, the figures and the description relating to the figures. The features and combinations of features mentioned in the description above as well as the features and combinations of features mentioned in the description relating to the figures and the features and combinations of features shown merely in the figures can be used not only in the respectively given combination, but also in other combinations or on their own, without leaving the scope of the invention. This means that the individual features mentioned in the context of the disclosure as well as combinations of features can be combined to form further exemplary embodiments which are not explicitly explained in so far as they are not ruled out in respect of the type of lamp.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A reflector element for an electric lamp,
wherein the reflector element is constructed in such a way that it is designed for at least one of a photocatalysis and for color conversion of the light.

2. The reflector element as claimed in claim 1,
it has a plate-like carrier, which is formed from a transparent material and is coated with an at least partially reflective layer for color conversion.

3. The reflector element as claimed in claim 2,
wherein the carrier is formed from at least two different polymers, which have different refractive indices.

4. The reflector element as claimed in claim 2,
wherein in order to realize the photocatalysis, a coating with TiO₂ is applied at least to regions on a side of the carrier which faces a lamp.

5. The reflector element as claimed in claim 4,
wherein in order to realize the photocatalysis, a coating with TiO₂ is applied at least to the peripheral regions of the reflector element, on a side of the carrier which faces a lamp.

6. The reflector element as claimed in claim 1,
wherein the reflector is designed for color conversion of light from a light source with a first color temperature to light with a second color temperature, which is lower than the first color temperature,
wherein the transmitted light has a higher or a lower color temperature in comparison with the first color temperature of the light source.

7. The reflector element as claimed in claim 1,
wherein the partially reflective layer is a wavelength-selective coating,
wherein the transmitted light has a higher or a lower color temperature in comparison with the first color temperature of the light source.

8. The reflector element as claimed in claim 1,
wherein the reflector element is designed for light scattering, and
wherein scattering bodies which are formed at least partially from a phosphor material are provided for light scattering.

9. The reflector element as claimed in claim 8,
wherein scattering bodies which are formed at least partially from a phosphor material of the type YAG:Ce are provided for light scattering.

10. The reflector element as claimed in claim 8,
wherein the phosphor material is at least one of formed as an additional layer on the carrier and admixed to the coating with TiO₂.

11. The reflector element as claimed in claim 8,
wherein the phosphor material is introduced into the material of the carrier.

12. A lamp, comprising:
a light source; and
a reflector element, wherein the reflector element is constructed in such a way that it is designed for at least one of a photocatalysis and for color conversion of the light.

13. The lamp as claimed in claim 12, further comprising:
an electronic operating device and wherein electronic components of the operating device are arranged laterally with respect to the light source in a first housing part formed circumferentially around the light source.

14. The lamp as claimed in claim 12, further comprising:
a first reflector element arranged on a side facing the upper side of the lamp; and
a second reflector element arranged on a side facing the lower side of the lamp.

15. The lamp as claimed in claim 14,
wherein the first and second reflector elements are each a dielectric mirror.

16. The lamp as claimed in claim 12,
wherein the lamp is designed for bidirectional emission, and in that in each case different dichroic mirrors are used as reflector elements for the two emission directions, wherein a first mirror is configured to primarily reflect the blue components in the spectrum of the lamp, and a second dichroic mirror is configured to primarily reflect the red components in the spectrum of the lamp.

17. The lamp as claimed in claim 16,
wherein the first mirror is a lower mirror; and
wherein the second mirror is an upper mirror.

18. The lamp as claimed in claim 14,
wherein at least regions of the first reflector element are coated with TiO₂ on the side facing the discharge vessel, and at least regions of the second reflector element are coated with a color conversion layer on the side facing the discharge vessel.

19. The lamp as claimed in claim 12,
wherein at least a second housing part in which the at least one light source is arranged is designed to be open on at least one of the upper side and the lower side so as to allow air to flow through.

20. The lamp as claimed in claim 12,
wherein at least one reflector element is arranged detachably on one side of the light source.
